(19) United States
(12) Patent Application Publication
(10) Pub. No.: US 2017/0039658 A1
(43) Pub. Date: Feb. 9, 2017

(54) ENERGY COLLABORATION PLATFORM WITH MULTIPLE INFORMATION LEVEL MATCHING

(71) Applicant: AQUILON ENERGY SERVICES, INC., Lisle, IL (US)

(72) Inventors: Jeffrey K. Wagner, Wheaton, IL (US); MIchael E. Egan, Winnetka, IL (US)

(21) Appl. No.: 15/226,152

(22) Filed: Aug. 2, 2016

Related U.S. Application Data
(60) Provisional application No. 62/200,155, filed on Aug. 3, 2015.

(51) Int. Cl. G06Q 50/06

(52) U.S. Cl. CPC G06Q 50/06

(57) ABSTRACT

Methods and systems for automatically matching energy transactions between two or more counterparties. One embodiment provides receiving, with a server, first transaction type data from a first counterparty involved in an energy transaction. Embodiments can also provide establishing, with the server, a sequence of concatenated data fields based on the first transaction type data for a first data level. The sequence of concatenated data fields to a second transaction type data associated with a second counterparty involved in the energy transaction are compared. One or more variances between the sequence of concatenated data fields and the second transaction type data are identified. Additional information for a second data level from at least one counterparty involved in the energy transaction is requested to address the one or more variances.

### RELATED APPLICATIONS

This application claims priority to U.S. Provisional Patent Application No. 62/200,155 filed Aug. 3, 2015, the entire content of which is hereby incorporated by reference.

### FIELD

Embodiments of the present invention relate to methods and systems for managing and settling wholesale energy trading transactions between counterparties.

### BACKGROUND

Energy companies trade wholesale energy transactions with bilateral counterparties for various energy commodity products, including but not limited to electricity, electricity capacity, electricity ancillary services, electricity transmission (which trades in various combinations as “power”), coal, renewable energy, renewable energy credits, crude oil, distillate fuels, natural gas, and financial swaps and options linked to energy commodity products.

### SUMMARY

Wholesale energy transactions are currently invoiced on a 30-day cycle, with the operational and financial accounting activities beginning on the first day of the month following the transaction delivery. Invoices are typically distributed on the 10^{th} business day of the month following the transaction delivery month, with payments due on the 20^{th} business day of the month (10 days after the receipt of the invoice). The existing invoice cycle is labor-intensive and inefficient, forcing trading organizations to hold high levels of unsecured credit exposure and/or post significant amounts of collateral or provide balance sheet commitments to support their energy trading activity.

During the transaction delivery month, transaction details, such as quantity, price, delivery point, date, e-Tag, and time, are entered into a transaction system of record (such as an Energy Trading Risk Management (“ETRM”) system). During the first few days of the month following the delivery month, the invoicing process for the previous month's transactions begins. Transaction counterparties conduct a process known as tie-out with each counterparty to whom they delivered or traded an energy product during the previous month. The purpose of the tie-out process is to ensure that counterparties agree to the transaction details (date, term, volume and price) prior to the invoice being generated and distributed. During the tie-out process, the counterparties manually review (e.g., via phone, fax, or email) the transaction volume and price for each transaction that is to be included on the monthly invoice. The manual tie-out effort is very time-consuming, tedious and subject to a high degree of error due to the requirement that both counterparties exactly match the information provided by the other counterparty to approve the invoiced transactions. Each transaction delivered during the previous month must be tied out or matched and approved by the bilateral counterparty for inclusion on the monthly invoice.

Transactions without any discrepancies (i.e., “matched”) are ready to be invoiced. If there are any transactions with a discrepancy (i.e., “out-trades”), the counterparties attempt to resolve the out-trade prior to issuing the invoice, potentially delaying the distribution of the invoice for those transactions for which there were no discrepancies (i.e., matched transactions). To resolve the out-trades, the bilateral counterparties download transaction data from one or more internal proprietary systems in a format that can be shared with the transaction's bilateral counterparty (e.g., spreadsheets sent via fax, emails, or other manual off-line systems), which enables bilateral counterparties to view the other counterparty's representation of the transaction details. Settlement analysts from both counterparties then manually identify and reconcile the out-trade discrepancy data for each out-trade transaction (e.g., date, term, volume, price, delivery point, index), manually determine the adjustment(s) to be made by each counterparty, and facilitate adjustments to the transaction system(s) of record (e.g., ETRMs) to correct the discrepancies prior to invoicing the transaction. The manual matching of transactions and the reconciliation of out-trade transactions is a time-consuming and cumbersome process. Resolution of each out-trade may also result in a manual adjustment to a transaction for inclusion on the invoice, the need to make a change to the transaction data in the transaction system of record, or, if both counterparties are unable to agree on the transaction details on a timely basis, a formal dispute being lodged against the bilateral counterparty. Resolution details of an out-trade are sometimes, but not always, noted in the transaction system of record.

The bilateral transaction counterparties also execute master energy purchase and sale agreements that govern the terms and conditions for the transactions, including the invoicing period, the timeliness of payment, the payment options, the responsibility for initiating the generation of invoices, and the process for resolving disputed transactions. Accordingly, each transaction must adhere to the terms and conditions of the master agreements, the terms of which can differ between different trading counterparties.

Following a successful manual tie-out process, the matched transactions are ready to be invoiced. A bilateral counterparty to whom payment is due (i.e., the “payee”) prepares an external invoice and distributes it to the bilateral counterparty from which a payment is due (i.e., the “payor”). The external invoice is then distributed to the payor (e.g., by email, fax, secure FTP site, or other manual off-line systems). The payor also prepares an internal invoice. The internal invoice is not distributed, but is used for control purposes to confirm the amount due on each external invoice received from the payee.

An accounts receivable analyst associated with the payee monitors on-line bank reconciliation reports for both “full” and “partial” payments from the payor. Upon bank payment confirmation of a “full” payment (i.e., 100% of the invoice amount), the accounts receivable analyst changes the invoice status from “issued” to “paid” (e.g., in the payee's ETRM), which completes the invoice cycle for the payee. Upon bank payment confirmation of a “partial” payment (i.e., less than 100% of the invoice amount), the accounts receivable analyst changes the invoice status from “issued” to “partially paid” and confirms that a dispute has been created covering the remaining invoice unpaid balance.

For invoices for which a payment is due, an accounts payable analyst associated with the payor waits to receive an invoice from the payee (e.g., via email, fax, through an FTP site, etc.). Upon receipt of the invoice, the accounts payable analyst manually reviews the received invoice to ensure the internal invoice is consistent with the received invoice. If the invoices are inconsistent, the accounts payable analyst works with the payee to resolve discrepancies, potentially delaying full payment. If the received invoice is consistent with the internal invoice, the accounts payable analyst prepares an invoice packet that includes the received invoice and the internal invoice, banking information, and supporting documentation used to prepare the invoice, including any comments from the tie-out process. The invoice packet is reviewed by the payment party's management and then approved for payment execution. The account payable analyst then executes the bank payment arrangements to pay the payee and changes the invoice status to “paid” (e.g., in the payor's ETRM), which completes the invoice cycle. Payment to a party can be made using bank checks, wire transfers, or ACH. If the received invoice is inconsistent with the internal invoice and resolution of the discrepancy is not possible by the required payment date of the terms of the master energy purchase and sale agreement executed between the counterparties, the accounts payable analyst associated with the payor prepares an invoice packet to pay a “partial payment” and at the same time initiates a dispute with the payee for the difference between the invoice amounts.

Throughout the invoice development and execution process, the financial accounting department for each party pulls information from the operational accounting system of record to determine revenue and power purchase accruals and actuals for the previous month, to manually make appropriate journal entries in the financial accounting system of record, to project cash flows for movement of funds, and to adjust the credit exposure information associated with each counterparty.

Accordingly, embodiments of the invention provide systems and methods for managing the bilateral counterparty (e.g., direct or indirect) wholesale energy transaction settlement process. In particular, the systems and methods provide collaborative, on-line workspaces that manage the workflows and notifications for tie-out, invoicing, payment execution, dispute management, and credit management activities associated with settlement of wholesale energy transactions. As used in the present application, the terms “collaborate” or “collaborative” includes providing a seamless workflow between two or more entities. For example, the workflow allows two or more independent parties to participate in a seamless workflow containing multiple steps, check-points, and confirmations. In particular, parties can access information associated with transactions and make changes and/or comments regarding the information. The workflow also automatically notifies parties of changes and/or comments made by other parties or other tasks required of a party to progress the workflow. In some embodiments, the workflow can also be automated if the parties are willing to turn this feature “on.”

In some embodiments, the systems and methods provide an interactive, on-line tool that automatically matches bilateral counterparty wholesale energy transactions during the tie-out process. Some embodiments also create and pay invoices, which ensure that invoices are issued on time and securely facilitate payment of bilateral transactions. Using the previously-mentioned functionality, some embodiments shorten the invoice cycle from monthly to weekly or daily, which reduces counterparty credit exposure and the capital necessary to transact. For example, in some embodiments, the systems and methods provide automatic transaction matching, tie-out, and settlement (e.g., invoicing) at level consistent with a unit of trade associated with the transactions (e.g., hourly).

Embodiments of the invention also provide a collaborative, on-line tool to coordinate between bilateral transaction counterparties to resolve disputed transactions and to reduce bilateral counterparty credit exposure to wholesale energy transaction bilateral counterparties.

For example, one embodiment of the invention provides a method of managing wholesale energy trading transaction between a first party and a second party. The method includes creating a tie-out period, receiving first transaction details from a transaction system of record of the first party, and determining a set of the first transaction details from the first party for inclusion in the tie-out period. The method also includes receiving second transaction details from a transaction system of record of the second party, determining a set of the second transaction details from the second party for inclusion in the tie-out period, automatically, by the server, matching the set of the first transaction details with the set of the second transaction details to identify a matched transaction, and making the matched transaction available for review by the first party and the second party.

In some embodiments, the systems and methods provide for automatically matching energy transactions between two or more counterparties. Some embodiments also provide receiving first transaction type data from a first counterparty involved in an energy transaction. Embodiments can also provide establishing a sequence of concatenated data fields based on the first transaction type data for a first data level. The sequence of concatenated data fields to a second transaction type data associated with a second counterparty involved in the energy transaction. One or more variances between the sequence of concatenated data fields and the second transaction type data are identified in some embodiments. Additional information for a second data level from at least one counterparty involved in the energy transaction is requested to address the one or more variances.

Other aspects of the invention will become apparent by consideration of the detailed description and accompanying drawings.

### BRIEF DESCRIPTION OF THE DRAWINGS

FIG. 1 schematically illustrates an energy collaboration platform (“ECP”) according to one embodiment of the invention.

FIG. 2 is a flowchart illustrating a wholesale energy transaction settlement process performed by the ECP of FIG. 1.

FIG. 3 is a flowchart illustrating a transaction selection process performed by the ECP of FIG. 1.

FIGS. 4A and 4B is a flowchart illustrating a collaborative tie-out process performed by the ECP of FIG. 1.

FIG. 5 is a flowchart illustrating an invoicing process performed by the ECP of FIG. 1.

FIG. 6 is a flowchart illustrating a dispute management process performed by the ECP of FIG. 1.

FIG. 7 is a flowchart illustrating a payment execution process performed by the ECP of FIG. 1.

FIG. 8 is a flowchart illustrating a credit management process performed by the ECP of FIG. 1.

FIG. 9 is a create tie-out screen provided through the ECP of FIG. 1 during the transaction selection process of FIG. 3.

FIG. 10 is a notification generated by the ECP of FIG. 1 during the transaction selection process of FIG. 3.

FIG. 11 illustrates wholesale energy trade transaction information processed during the transaction selection process of FIG. 3 and the collaborative tie-out process of FIGS. 4A and 4B.

FIG. 12 is a view trades screen provided through the ECP of FIG. 1 during the transaction selection process of FIG. 3.

FIG. 13 is a view tie-outs screen provided through the ECP of FIG. 1 during the collaborative tie-out process of FIGS. 4A and 4B.

FIGS. 14, 15, and 17 are tie-out collaborate screens provided through the ECP of FIG. 1 during the collaborative tie-out process of FIGS. 4A and 4B.

FIGS. 16 and 18-19 are notifications generated by the ECP during the collaborative tie-out process of FIGS. 4A and 4B.

FIG. 20 is a create invoice screen provided through the ECP during the invoice management process of FIG. 5.

FIG. 21 is a view invoices screen provided through the ECP during the invoice management process of FIG. 5.

FIGS. 22 and 23 are invoice collaborate screens provided through the ECP during the invoice management process of FIG. 5.

FIGS. 24 and 25 are notifications generated by the ECP during the invoice management process of FIG. 5.

FIG. 26 is a create dispute screen provided through the ECP during the dispute management process of FIG. 6.

FIG. 27 is a view disputes screen provided through the ECP during the dispute management process of FIG. 6.

FIGS. 28 and 29 are dispute collaborate screens provided through the ECP during the dispute management process of FIG. 6.

FIGS. 30 and 31 are notifications generated by the ECP during the dispute management process of FIG. 6.

FIG. 32 is a create payment screen provided through the ECP during the payment execution process of FIG. 7.

FIG. 33 is a view payments screen provided through the ECP during the payment execution process of FIG. 7.

FIGS. 34 and 35 are payment collaborate screens provided through the ECP during the payment execution process of FIG. 7.

FIGS. 36 and 37 are notifications generated by the ECP during the payment execution process of FIG. 7.

FIG. 38 is a create counterparty credit screen provided through the ECP during the credit management process of FIG. 8.

FIG. 39 is a view credit screen provided through the ECP during the credit management process of FIG. 8.

FIGS. 40 and 41 are credit collaborate screens provided through the ECP during the credit management process of FIG. 8.

FIGS. 42-44 are notifications generated by the ECP during the credit management process of FIG. 8.

FIG. 45 illustrates relationships between levels of information in an energy settlement workbook.

FIG. 46 illustrates multiple levels of information contained in an energy settlement workbook.

FIG. 47 is a flowchart illustrating a multiple-level matching process performed by the ECP of FIG. 1.

FIG. 48 is a flowchart illustrating a process for automatically matching energy transactions between two or more counterparties that is performed by the ECP of FIG. 1, in accordance with one embodiment of the invention.

FIG. 49 is a flowchart illustrating a tie-out process between information systems associated with two or more counterparties performed by the ECP of FIG. 1, in accordance with one embodiment of the invention.

### DETAILED DESCRIPTION

Before any embodiments of the invention are explained in detail, it is to be understood that the invention is not limited in its application to the details of construction and the arrangement of components set forth in the following description or illustrated in the accompanying drawings. As described in subsequent paragraphs, the specific configurations illustrated in the drawings are intended to exemplify embodiments of the invention and that other alternative configurations are possible. Accordingly, the invention is capable of other embodiments and of being practiced or of being carried out in various ways.

Also, it is to be understood that the phraseology and terminology used herein is for the purpose of description and should not be regarded as limited. The use of “including,” “comprising” or “having” and variations thereof herein is meant to encompass the items listed thereafter and equivalents thereof as well as additional items. The terms “mounted,” “connected” and “coupled” are used broadly and encompass both direct and indirect mounting, connecting and coupling. Further, “connected” and “coupled” are not restricted to physical or mechanical connections or couplings, and can include electrical connections or couplings, whether direct or indirect. Also, electronic communications and notifications may be performed using any known means including direct connections, wireless connections, etc.

It should also be noted that a plurality of hardware and software based devices, as well as a plurality of different structural components may be utilized to implement the invention.

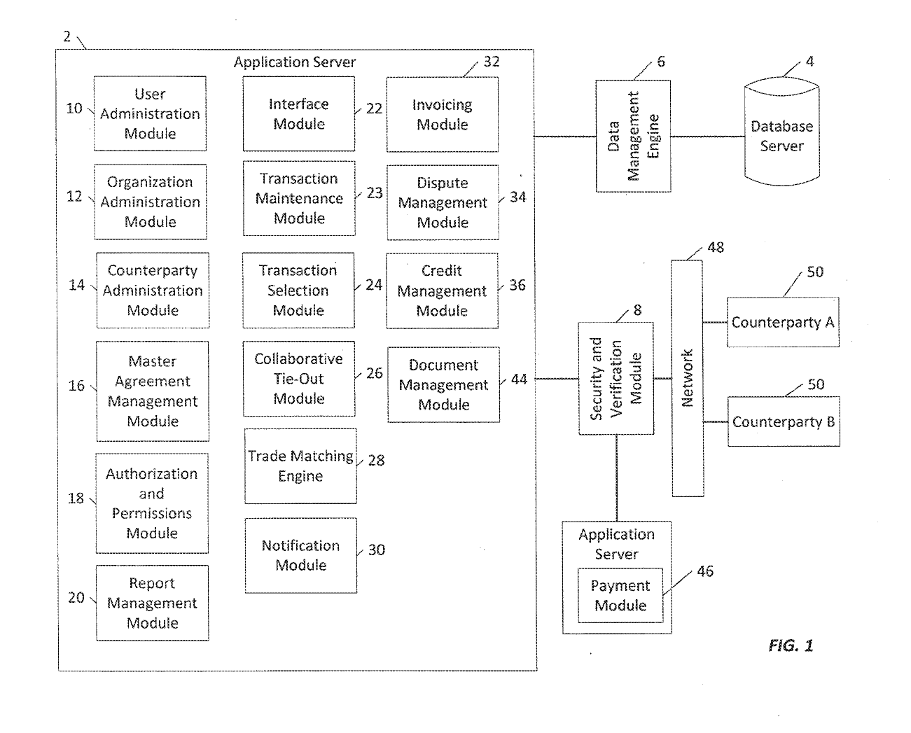

FIG. 1 illustrates an energy collaboration platform (“ECP”) according to one embodiment of the invention. The ECP includes an application server 2, a data management engine 6, a database server 4, a security and verification module 8, a network 48 (such as the Internet or other networks individually or in combination with the Internet), and participating organizations or individuals 50 (hereinafter “counterparty,” “party,” “organization,” “participant,” or “user”). As illustrated in FIG. 1, the ECP also includes a payment module 46, which can include an automated clearing house (“ACH”) system, a wire transfer system, a debit card system, a credit card system, a check generating system (e.g., that can generate checks, drafts, bills of exchange, promissory notes, IOUs, debit notes, or other negotiable instruments), or any other suitable electronic funds transfer (“EFT”) system. The payment module 46 can be included in the application server 2 or in a separate server or computing device. The security and verification module 8 verifies that a particular organization and/or participant is authorized to access the ECP.

It should be understood that the application server 2 and the other servers and computing devices described herein include standard components of a computing device. In particular, the application server 2 can include a processing unit (e.g., a microprocessor), one or more non-transitory computer-readable memory modules (e.g., including random access memory, read-only memory, etc.), and an input/output interface. The processing unit fetches and executes instructions stored in the memory modules. The memory modules can also store data used or created by the processing unit as part of executing instructions. The input/output interface allows the server 2 to communicate with devices, systems, and networks external to the server 2. Similarly, it should be understood that the “modules” and “engines” described in the present application can be implemented as software (i.e., instructions) executed by a processing unit to perform particular functionality. In particular, the functionality described herein for the “modules” and “engines” may be performed through one or more processing units executing instructions.

The application server 2 (i.e., the memory modules included in the server 2) stores and provides access to a user administration module 10, an organization administration module 12, a counterparty administration module 14, a master agreement management module 16, an authorization and permissions module 18, a report management module 20, an interfaces module 22, a transaction maintenance module 23, a transaction selection module 24, a collaborative tie-out module 26, a real-time trade matching engine 28, a notification module 30, an invoicing module 32, a dispute management module 34, a credit management module 36, the payment module 46, a document management module 44, a data management engine 6, and a database server 4. It should be understood that the components of the application server 2 may be combined in a different manner than as shown and described in FIG. 1. Also, the architecture of the modules and engines of the application server 2 can be independent of each other or may be combined in different configurations.

The user administration module 10 stores and maintains individual user accounts, roles, and permissions for individuals accessing the ECP. The organization administration module 12 stores and maintains organizational information, including but not limited to corporate, banking, and system interface integration configuration information. The counterparty administration module 14 stores and maintains relationship information between the organization and the organization's counterparties. In some embodiments, information maintained by the counterparty administration module 14 is used as system configuration information for the notification module 30, the credit management module 36, the payment module 46, the dispute management module 34, the collaborative tie-out module 26, and/or the invoicing module 32.

The master agreement management module 16 stores and maintains master agreement contract information between the organization and the organization's counterparty. The stored data can include, but is not limited to, invoicing cycle information (e.g., daily, weekly, monthly), invoice creation date (e.g. 10^{th} business day of month), payment due day (e.g. 20^{th} of month (10 days after receipt of invoice)), credit limits, and collateral requirements. In some embodiments, the ECP utilizes master agreement information to customize the creation of the tie-out period, transaction matching, invoice creation, and ECP-generated notifications to participants of the ECP. The ECP can also use master agreement credit limits and collateral requirements in the credit management module 36.

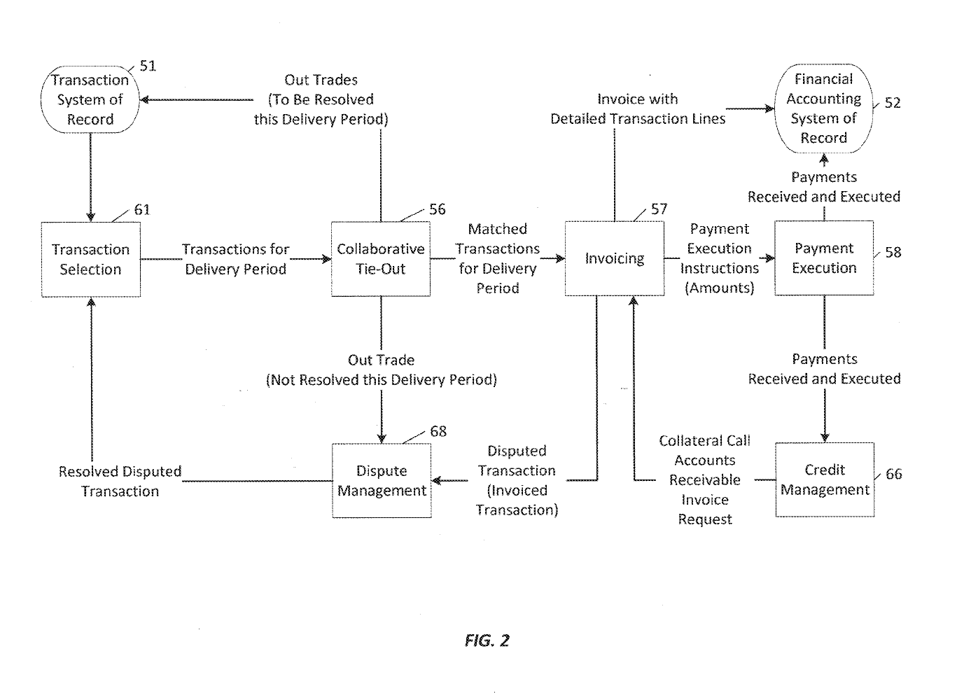

The authorization and permissions module 18 identifies and stores authorizations, permissions, and roles for users of ECP. For example, a participant may have an ECP role of “Invoice Approver” but not have the role of “Payment Disburser.” Accordingly, the user assigned as the “Invoice Approver” may not have the authorization and permission to disburse payments but has the authorization and permission to approve invoices. The authorizations and permissions module 18 also may be configured to determine the amount of authority that a user has to perform a particular function, such as approving invoices. For example, a participant may have the role of “Payment Approver” but only up to a specified amount of the invoice (e.g., authority to approve invoices up to $100,000). Additionally, the authorizations and permissions module 18 may be configured to assign users to specific counterparties so that a user has authority to act in a specific role when working with a specific counterparty. For example, a participant may have the role of “Invoice Approver” when working on transactions with Counterparty D but not be authorized as “Invoice Approver” for any other counterparties. Accordingly, each counterparty can uniquely configure the authority of their authorized users resulting in a unique workflow during the processing of transactions through FIG. 2.

The report management module 20 facilitates the generation of printable reports and/or data exports. In some embodiments, the report and exports are stored in the database server 4, which is securely accessible through the data management engine 6. Reports may be produced in printed format or in downloadable data formats. For example, a participant may produce a report of all out-trades with a specific counterparty for a specific tie-out period. The participant may then export this data in a particular format, such as in a Microsoft Excel format.

The interfaces module 22 interfaces ECP to external systems. These systems include, but are not limited to, ETRM systems, transaction confirmation systems, treasury systems, accounting systems, credit management systems, collateral management systems, and depository financial institution systems (payment processing). The interfaces module 22 transmits data to and/or receives information from external systems.

The transaction maintenance module 23 allows a participant to modify transactions including trade transactions, tie-outs, invoices, payments, and disputes in the ECP. For example, in some embodiments, the ECP receives an imported transaction through the interfaces module 22 and updates the transaction on the database using the data management engine 6 and the database server 4. In other embodiments, a participant manually enters the wholesale energy trade transaction modifications online using the transaction maintenance module 23 to modify transactions in the ECP without an import through the interfaces module 22.

The transaction selection module 24 allows a participant to select one or more trade transactions in the ECP and associate the trade transactions. For example, in some embodiments, the transaction selection module 24 is accessed by the collaborative tie-out module 26 to associate trade transactions with a tie-out. In another embodiment, the transaction selection module 24 is accessed by the invoicing module 32 to associate trade transactions with an invoice.

The collaborative tie-out module 26 allows a participant to establish a settlement tie-out between counterparties to financially settle wholesale energy trade transactions. The tie-out period (i.e., the time period to financially settle wholesale energy trades—also sometimes referred to as a delivery period) is determined by accessing the master agreement management module 16 which stores the agreed upon tie-out period between the counterparties which can be, but is not limited to, monthly or some other agreed upon tie-out period.

The trade matching engine 28 performs real-time wholesale energy trade transaction matching of buy-to-sell and sell-to-buy transactions. As transactions are imported or manually entered with the transaction maintenance module 23, the trade matching engine 28 applies an algorithm to identify matching transaction pairs. Transactions that matched are set or stored as “Matched” transactions and transactions that do not match are stored as “Out-Trade” transactions. The trade matching engine 28 can be used within the collaborative tie-out module 26.

The notification module 30 generates notification and/or alert messages when actions are required and/or for informational purposes. Notifications include, but are not limited to, email, text messages, and ECP-viewable messages.

The invoicing module 32 allows a participant to issue an invoice for financial settlement of one or more tie-outs determined by accessing the collaborative tie-out module 26. Each invoice contains on or more tie-outs resulting in the creation of a “net” invoice between counterparties. The invoice details (e.g., including due date, payment method, and associated financial institution information) can be determined by accessing the master agreement management module 16 that stores the agreed upon invoicing information including due dates for invoices.

The dispute management module 34 allows a participant to manage disputes with one or more counterparties. For example, in some embodiments, the transaction selection module 24 is accessed by the dispute management module 34 to open a dispute with selected wholesale energy trade transactions that are out-trades. In another embodiment, the dispute management module 34 accesses the invoicing module 32 to open a dispute with an invoice. In yet another embodiment, the dispute management module 34 accesses the payment module 46 to open a dispute with a payment.

The credit management module 36 allows a participant to manage credit exposure with counterparties. For example, in some embodiments, the credit management module 36 determines the credit exposure to a counterparty by calling the transaction selection module 24 (e.g., to determine transaction activity with the counterparty and calculate the associated credit exposure). In another embodiment, the credit management module 36 accesses the master agreement management module 16 (e.g., to access collateral communication information) to notify a counterparty exceeding the credit limit. In some embodiments, the credit management module 36 generates such a collateral call notification by providing information to the notification module 30.

The document management module 44 generates and stores ECP-generated documents and attached uploaded supporting documents. The document management module 44 also provides custom document templates and the ability to upload supporting documents that can be associated with an ECP-generated document. For example, in some embodiments, the ECP generates an invoice from an organization custom template. The user then uploads scanned supporting documentation and attaches these documents to the ECP-generated invoice.

The data management engine 6 stores and retrieves data from the database server 4. The data management engine 6 also verifies access authorization to data by calling the user administration module 10 to determine the authority level of a user.

The database server 4 facilitates the physical secure storage of data. In some embodiments, data is stored in a real-time database for very fast and low-latency data access. In other embodiments, the data is stored in a historical reporting database, which is not used for real-time access. Rather, the historical reporting data can be used to perform historical reporting which is not time sensitive.

As noted above, the security and verification module 8 verifies organizations and user participants that are authorized to access the ECP. Participants 50 can include, for example, Operational Settlement Analysts, Credit Analysts, Financial Accounting Analysts, Risk Analysts and Traders for the organization, and each counterparty organization on the ECP. Although not shown in FIG. 1, other participants 50 can include electric power Independent System Operators (“ISO”), natural gas storage and pipeline operators, crude oil and distillate shippers, refiners and pipeline operators, and, for ACH processing, originating depository financial institutions (“ODFI”) and receiving depository financial institutions (“RDFI”). The participants 50 can also include a settlement analyst (e.g., someone who performs the operational accounting activities, including accounts receivable and accounts payable tasks), a risk analyst (e.g., someone who updates transactional information in the system of record), an invoice reviewer (e.g., someone who performs operational accounting reviewing activities), an payment disbursement approver (e.g., someone who has the authority to approve payment disbursement), a credit analyst (e.g., someone who monitors bilateral counterparty credit exposure and issues collateral calls), and a financial accounting analyst (e.g., someone who reviews the operational accounting activities and enters the appropriate general ledger entries in the financial accounting system of record).

A participant 50 can use a computing device (e.g., a personal computer, a laptop computer, a tablet computer, a smart phone or device, etc.) to connect to the ECP over the network 48. The participants 50 can access the application server 2 to use the various modules, managers, and engines to manage the electricity wholesale transaction payment process. In some embodiments, the ECP can connect all participants to a web-based, real-time system, organize transactional information for a tie-out period, facilitate a transaction tie-out process, facilitate electronic submittals, reviews, and approval of invoices, and manage payment of invoices.

FIG. 2 is a flow chart illustrating a wholesale energy transaction settlement process that can be performed by participants 50 using the ECP and, in particular, the various module and engines stored on the application server 2. Based on configuration information established using the counterparty administration module 14 and the master agreement management module 16, the ECP performs the illustrated process or portions thereof in an automated, partially automated, or manual fashion.

As illustrated in FIG. 2, the process performed by the ECP can include a transaction selection process 61, which is performed by the transaction selection module 24. During a tie-out period (e.g., one month, one week, one day), wholesale energy trading organizations engage in bilateral transactions for both purchases and sales of wholesale energy products. At the completion of the tie-out period and following the delivery of the products, one of the counterparties initiates the tie-out process by identifying the transaction products (and the associated transaction details) that were delivered to the counterparty during the tie-out period and notifies the counterparty that a tie-out period is established. The transaction selection process 61 then establishes a tie-out period based on the identified transaction products, which is the period for which any purchases or sales (collectively called “transactions”) are included on the period's invoice. The tie-out period establishes the invoice billing period (e.g., one month, two weeks, or one day) by defining a start date and an end date. Any transactions that were delivered during the time period specified by the start date and the end data are eligible for the tie-out process and the subsequent invoicing process 57. During the transaction selection process 61, the bilateral transaction counterparties also determine a set of matched transactions that are included in the collaborative tie-out process for the established tie-out period.

The process illustrated in FIG. 2 also includes a collaborative tie-out process 56, which is performed by the collaborative tie-out module 26. Each transaction delivered during the period must be tied-out with a bilateral counterparty for inclusion on the tie-out period's invoice. This process 56 ensures that counterparties agree to the transaction details (e.g., volume and price) prior to the invoice being distributed. This process 56 facilitates on-line collaborative real-time automatic matching of transactions by accessing the trade matching engine 28 for wholesale energy transactions between the two bilateral counterparties. For example, the trade matching engine 28 automatically identifies the matched transactions that are included on the invoice for the defined tie-out period. The collaborative tie-out process 56 also establishes the transactions that do not match, referred to as “out-trades.” As a result of the collaborative tie-out process 56, the two bilateral counterparties identify the out-trades that can be resolved prior to inclusion on the tie-out period's invoice. The transaction data for these out-trades is revised in a transaction system of record 51 based on the collaborative tie-out process 56. In some embodiments, out-trades that are not resolved for this tie-out period are not included in the invoicing process 57 for the tie-out period and are processed by a dispute management process 68. In other embodiment, these transactions can be included in the invoicing process 57.

An invoicing process 57 is also illustrated in FIG. 2. The invoicing process 57 is performed by the invoicing module 32. The invoicing process 57 allows the parties to review and approve invoice amounts. Each invoice contains one or more tie-outs that allow for the creation of a “net” invoice between counterparties. After an invoice is reviewed and approved, the payment execution process 58 is performed.

The payment execution process 58 is performed by the payment module 46. The payment execution process 58 performs payments (i.e., ACH, wire transfers, etc.) and distributes the records of the payments received for export to a financial accounting system of record 52. As described in more detail below, handling the payments through the ECP reduces credit exposure by the credit management process 66.

As illustrated in FIG. 2, the process also includes a dispute management process 68, which is performed by the dispute management module 34. The process 68 enables bilateral transaction participants to track and manage out-trades that are not resolved during a tie-out period. The dispute management process 68 facilitates the on-line, collaborative resolution of each out-trade and disputed transaction. Upon resolution, based on the date of the underlying transaction, the resolved disputed transaction may be included in the current tie-out period or included in a future tie-out period as a “prior period adjustment” transaction.

The credit management process 66 is performed by the credit management module 36. The process 66 allows bilateral transaction counterparties to track and manage credit exposure and payment history. The process 66 also alerts participants 50 as margin thresholds approach or are exceeded, necessitating a collateral call. The credit management process 66 facilitates the on-line collaborative credit review between two bilateral transaction counterparties, as well as the issuance of a collateral call, if necessary. The credit management process 66 also supports the creation of an accounts receivable invoice in the amount of the collateral call which is processed in the invoicing process 57.

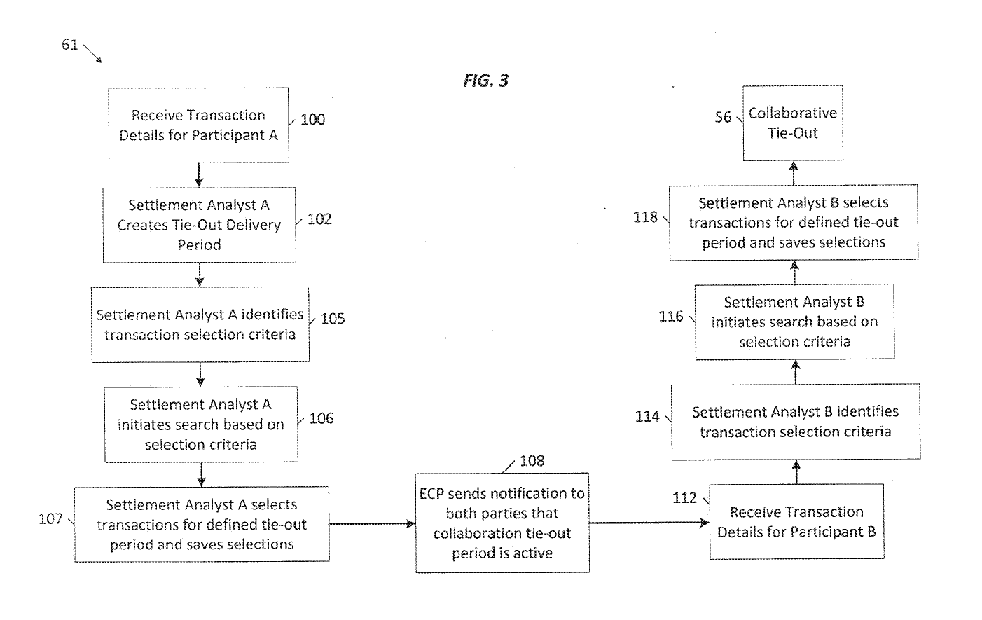

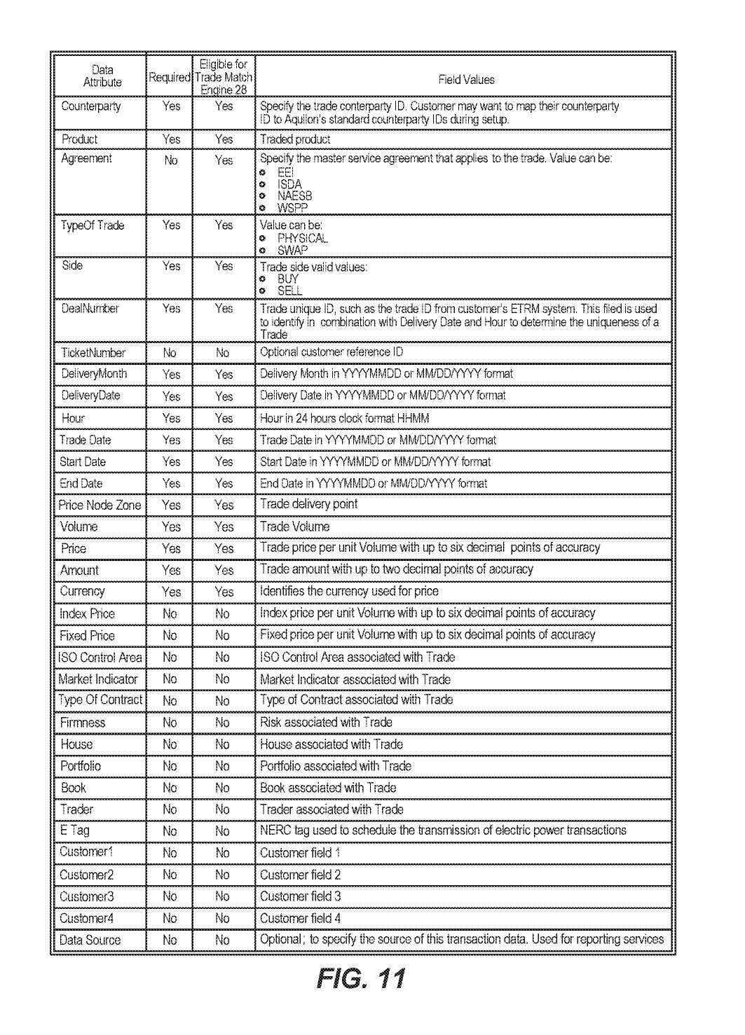

FIG. 3 illustrates the transaction selection process 61 in more detail. As illustrated in FIG. 3, to perform the transaction selection process 61, transaction details are received by the ECP (at block 100). The transaction details can be automatically imported from a party's transaction system of record 51 (e.g., through the interfaces module 22) and/or can be manually entered (e.g., through the transaction maintenance module 23). For example, in some embodiments, at a user-configurable periodicity, the ECP accesses the interfaces module 22 to automatically import transaction details from one or more participant's transaction system of record 51 into the database server 4. The transaction details imported include the executed transaction information, including but not limited to trade date, delivery date, buy/sell side, bilateral counterparty, product, term, price volume per hour and total volume, master agreement, trader, e-tag, broker, and transaction-specific comments entered by a trader or risk analyst. These details can be stored to the database server 4 using a database format as illustrated in FIG. 11.

After the transaction details are received, a tie-out period is created. In some embodiments, a settlement analyst from one of the bilateral transaction counterparties (e.g., “Settlement Analyst A” representing “Participant A”) defines a tie-out period (at block 102). For example, Settlement Analyst A can define a tie-out period by selecting the date range for which delivered transactions are tied out and included on the invoice. The tie-out period may coincide with the invoice or “billing” period or may occur on a different schedule. Alternatively or in addition, the ECP can be configured to automatically credit a tie-out period (e.g., based on configuration data established by the parties and/or one or more agreements between the parties as stored in the master agreement management module 16).

Based on the specified tie-out period, the ECP creates a tie-out period workspace for the defined tie-out period. As described in more detail below, the tie-out period workspace provides each counterparty with both a shared and a proprietary view of the transactional data included in the tie-out period workspace. The shared view presents public transactional information. The proprietary view presents proprietary data (e.g., data not to be shared with the counterparty).

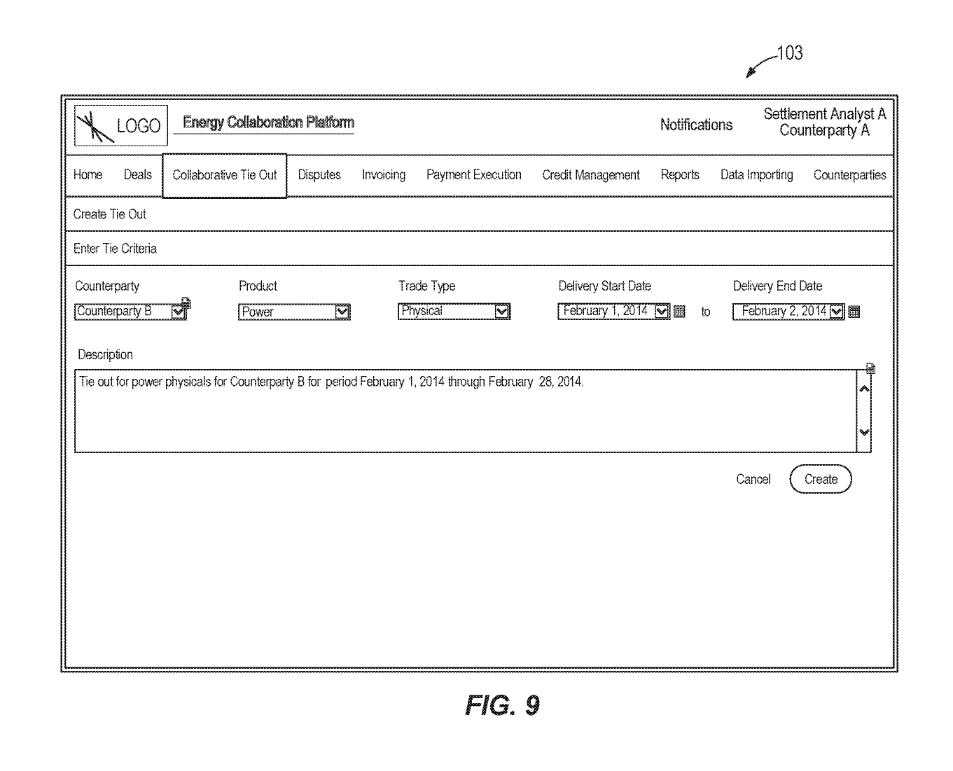

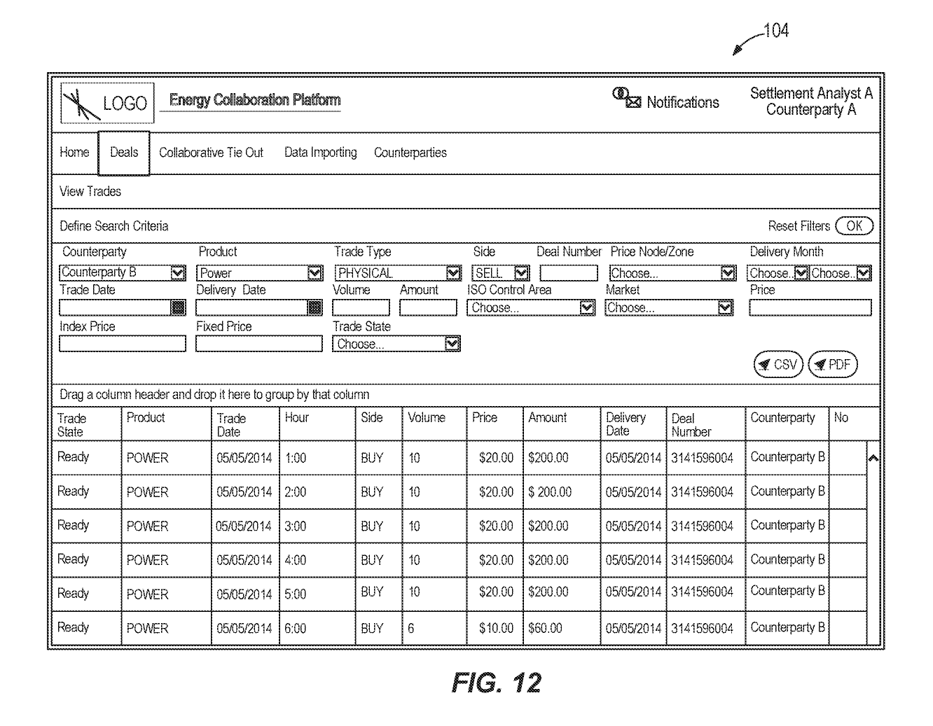

The Settlement Analyst A also selects transactions to be included in the collaborative tie-out process for the defined tie-out period using a create tie-out screen 103 (see FIG. 9). In some embodiments, to select a subset of the transactions from the database server 4 to add to the transaction selection workspace and consider for inclusion in the tie-out period, Settlement Analyst A can identify transaction selection criteria using a view trades screen 104 (see FIG. 12) (at block 105). The transaction selection criteria can include search criteria, including but not limited to trade date, delivery date, buy/sell side, bilateral counterparty, and product. Upon submitting the transaction selection criteria for execution (at block 106), the ECP executes a search based on the selection criteria against the transactions in the database server and presents a list of transactions that meet the search criteria. Settlement Analyst A can then select one or more transactions from the search list to add the transaction(s) to the tie-out period workspace (at block 107). The ECP allows a user to individual or groups of individual transactions (e.g., including all listed transactions) from a search list for addition to a tie-out period workspace. After selecting desired transaction(s), Settlement Analyst A saves the counterparty-specific tie-out period with the selected transactions. The transactions saved in the tie-out period workspace are then accessible for the collaborative tie-out process 56.

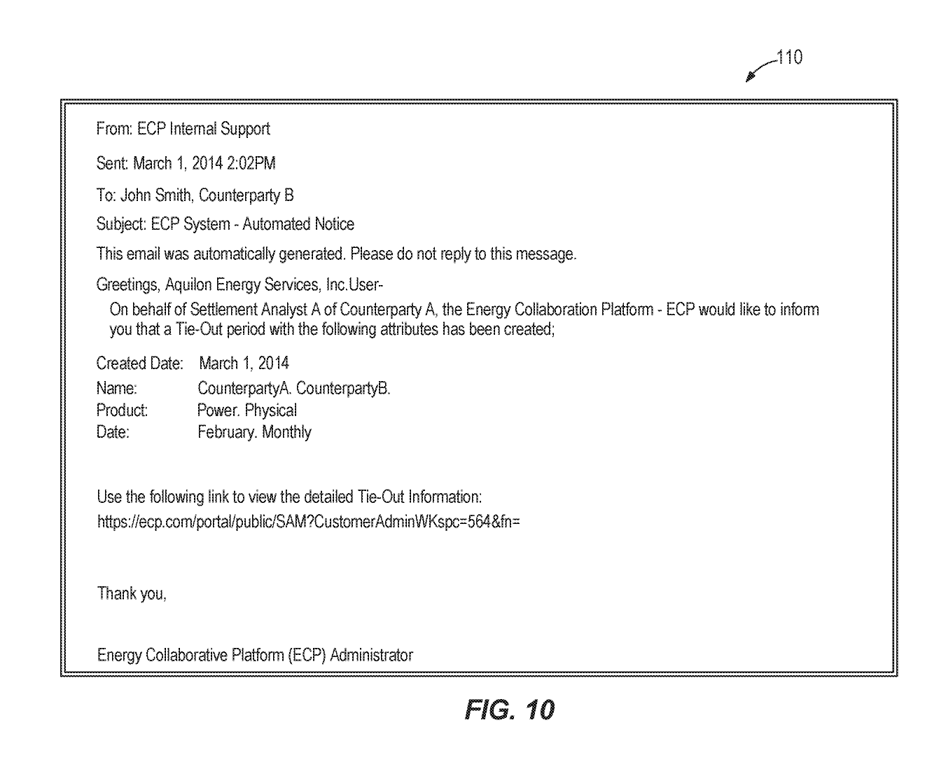

After the Settlement Analyst A selects the transactions for the tie-out period and/or selects the tie-out period, the ECP generates a tie-out notification 110 (see FIG. 10) and provides the notification 110 to both parties (at block 108). The notification 110 indicates that a collaboration tie-out period is active and identifies, among other details, the requesting bilateral counterparty and the defined tie-out period. The counterparty's settlement analyst (e.g., “Settlement Analyst B” representing “Participant B”) responds to the notification 110 by loading the transaction details from Participant B's transactional system of record for the transactions delivered during the defined tie-out period (at block 112). As described above, the details from Participant B can be imported automatically from Participant B's transaction system of record 51 via the interfaces module 22 and/or can be manually entered through the transaction maintenance module 23. After entering the details (e.g., automatically and/or manually), Settlement Analyst B can access the transaction selection workspace, identify the transaction selection criteria (at block 114), and submit a search for execution based on the selection criteria (at block 116). Settlement Analyst B then selects and saves transactions from the search results for inclusion in Participant A's collaborative tie-out process (at block 118). The transactions saved in the tie-out period workspace are ready for the collaborative tie-out process 56.

Accordingly, the transaction selection process 61 establishes the transactions that are included in the collaborative tie-out process 56 for an established tie-out period. Based on configuration information established using the counterparty administration module 14 and the master agreement management module 16, the ECP performs the transaction selection process 61 in an automated, partially automated, or manual fashion.

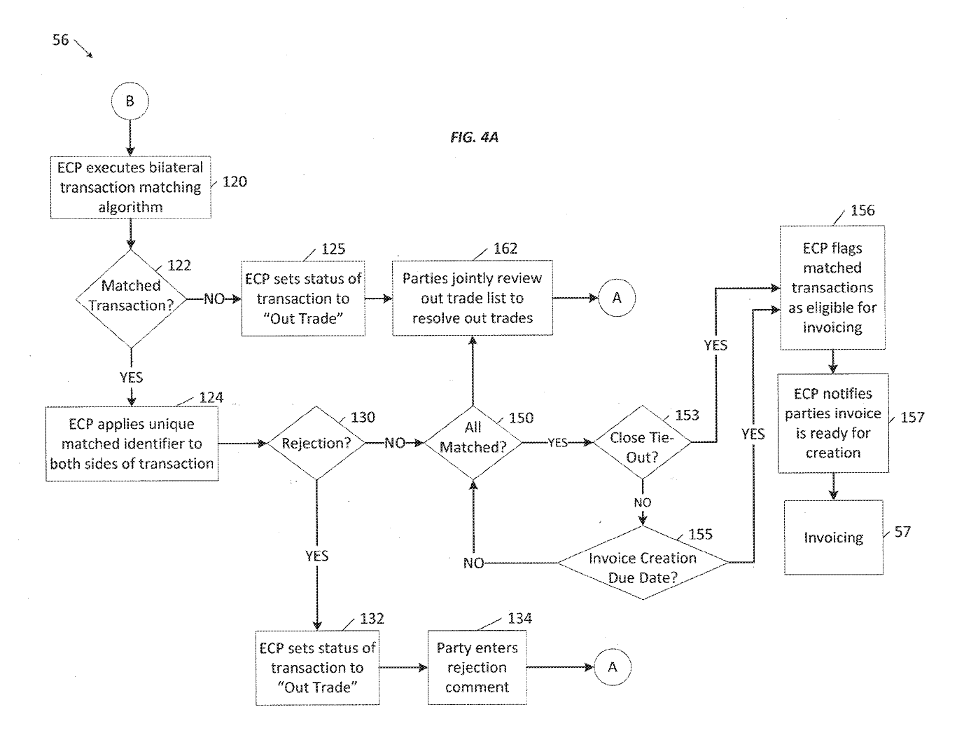

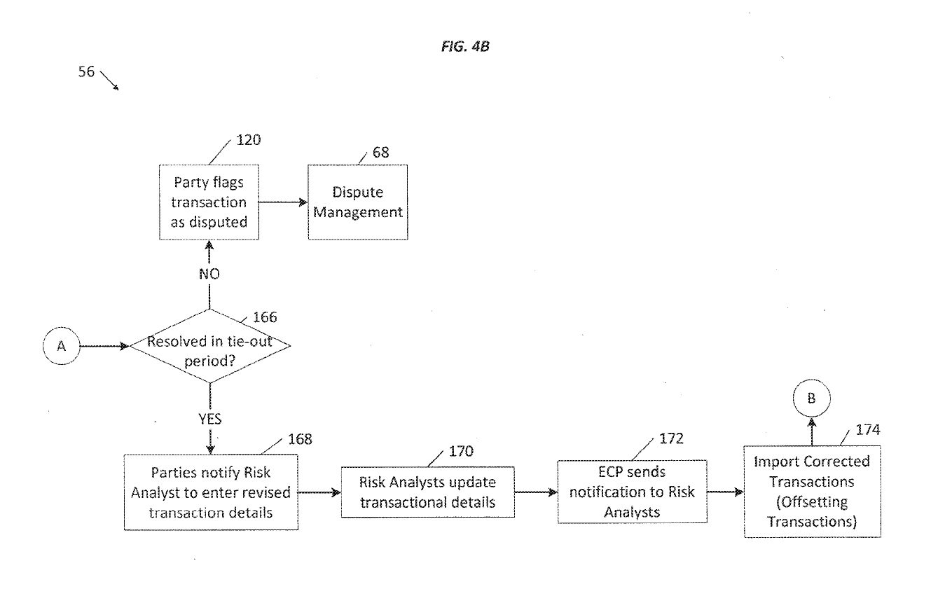

FIGS. 4A and 4B illustrate the collaborative tie-out process 56 in more detail. In particular, FIGS. 4A and 4B illustrate an example of two bilateral transaction counterparties (e.g., Participant A and Participant B) engaging in an on-line collaborative tie-out process during which the ECP performs real-time matches of one party's buy transactions with the other party's sell transactions (e.g., determines if specific transaction attributes are identical and match between Participant A's sell transaction with Participant B's buy transactions). For example, in some embodiments, as described above in FIG. 3, Settlement Analyst A establishes the tie-out period and selects the transactions for inclusion in the tie-out process. Prior to the execution of the bilateral transaction real-time matching algorithm, the ECP sets the transaction status for all transactions included in the workspace by Settlement Analyst A to “Out-Trade.” As the Settlement Analyst B loads transactions into the tie-out period workspace, the ECP executes a bilateral transaction real-time matching algorithm that pairs a transaction from Participant A's transaction tie-out period workspace list with a transaction from Participant B's transaction tie-out period workspace list (at block 120, see FIG. 4A). For example, in some embodiments, the bilateral real-time matching algorithm pairs two transactions if specific data attributes that are eligible for matching of the two counterparty transactions are identical (at block 122). These data attributes can include but are not limited to volume and price (and are provided on opposite sides of the transaction (buy/sell). FIG. 11 specifies other attributes that can be used by the matching algorithm. The ECP sets the transaction status for each pair of matched transactions to “Matched.” The ECP can also assign a unique matched identifier to the matching transactions on both sides of the transaction (at block 124). For example, if the bilateral transaction real-time matching algorithm matches two hourly power transactions, the ECP applies a unique matched identifier to both sides (buy and sell) of the transaction and designates the transactions as “Matched.” If transaction details are not matched, the transaction is set as “Out-Trade” (at block 125).

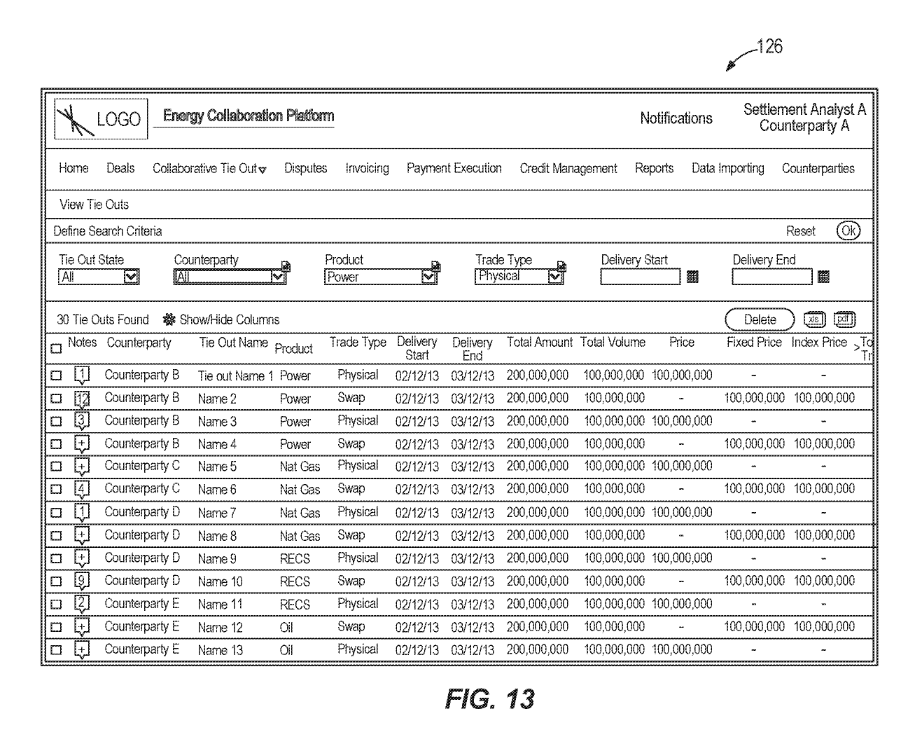

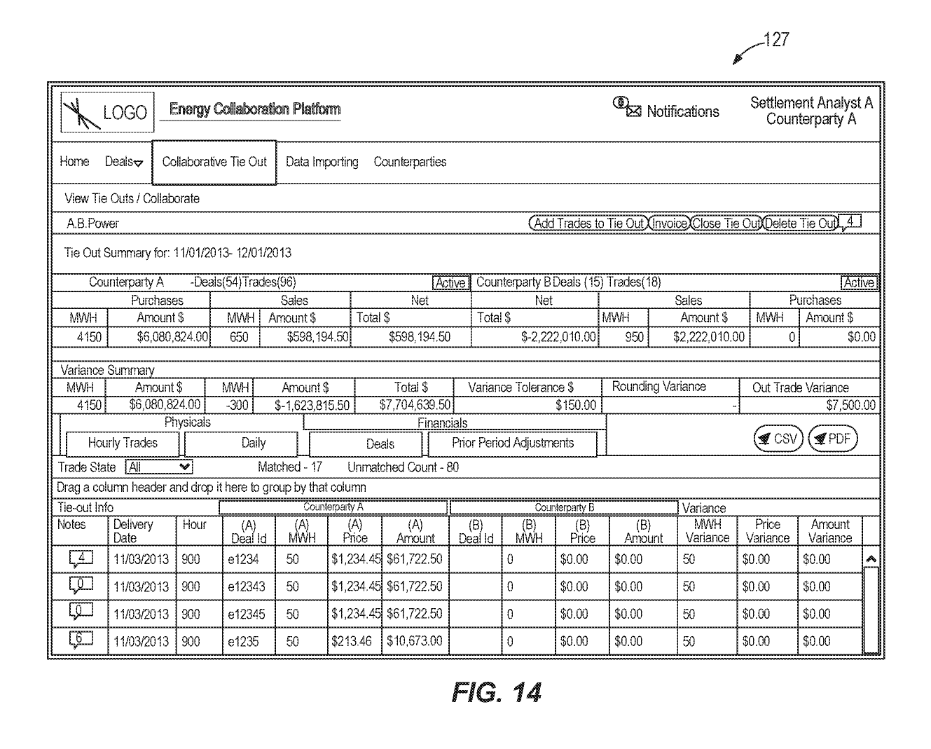

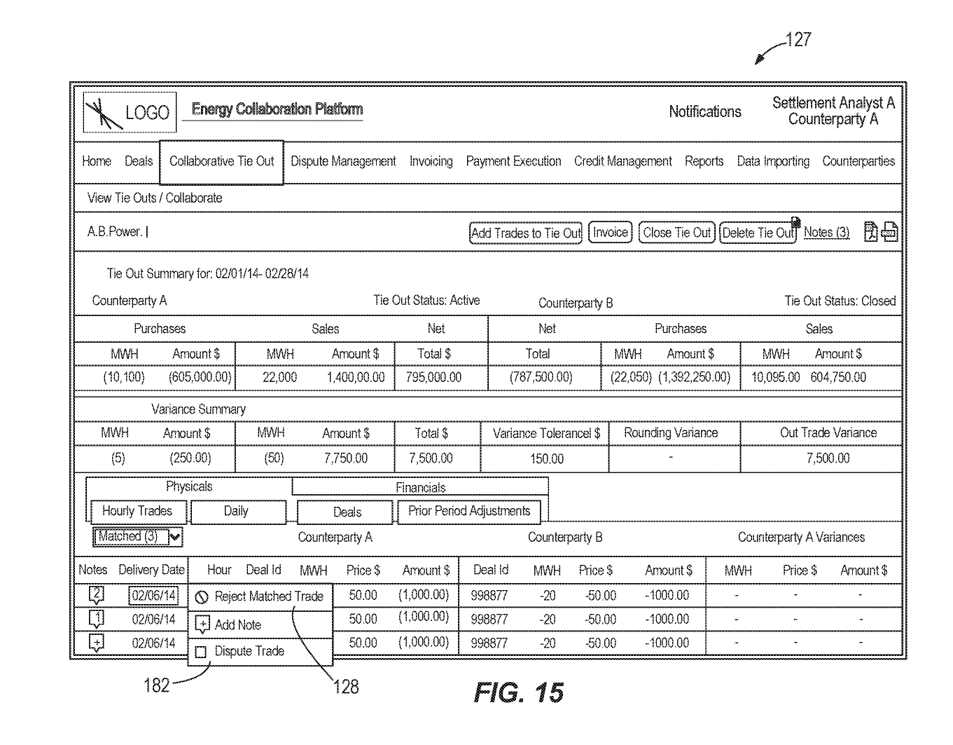

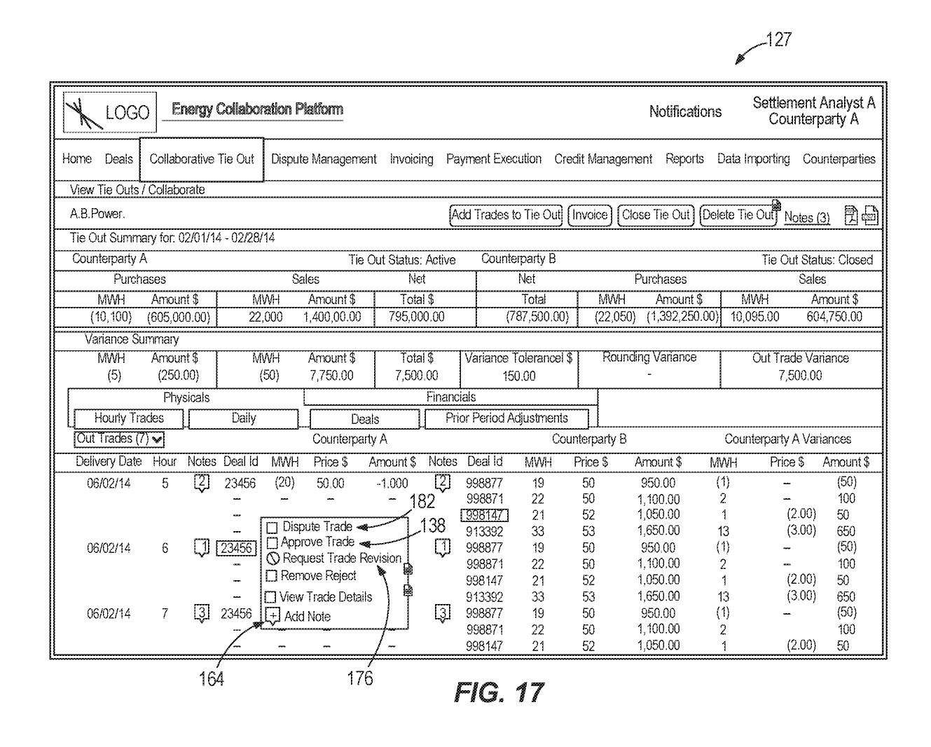

After the trade matching engine 28 performs the matching algorithm, the ECP presents the participants with a shared, collaborative, view of the tie-out period's matched transactions and the unmatched out-trade transactions using a view tie-outs screen 126 illustrated in FIG. 13 and a tie-out collaborate screen 127 illustrated in FIG. 14. The tie-out collaborate screen 127 enables each counterparty to view trade transaction data (e.g., for a specific tie-out period), in a shared on-line tie-out period workspace. The tie-out collaborate screen 127 can include a public section and a proprietary section that presents information about transactions presented in the shared tie-out period workspace. The public section presents public information and the proprietary section presents proprietary information. The proprietary information is only viewable by the owning participant. Together, the Settlement Analyst A and the Settlement Analyst B review and take action on both the matched and unmatched (i.e., out-trade) transaction lists in the tie-out collaborate screen 127. For example, each counterparty can independently approve or reject ECP-matched transactions and out-trades. In particular, as described in more detail below, a party can select one or more matched or out-trade transactions and perform a user action in the tie-out collaborate screen 127 (see FIGS. 15 and 17).

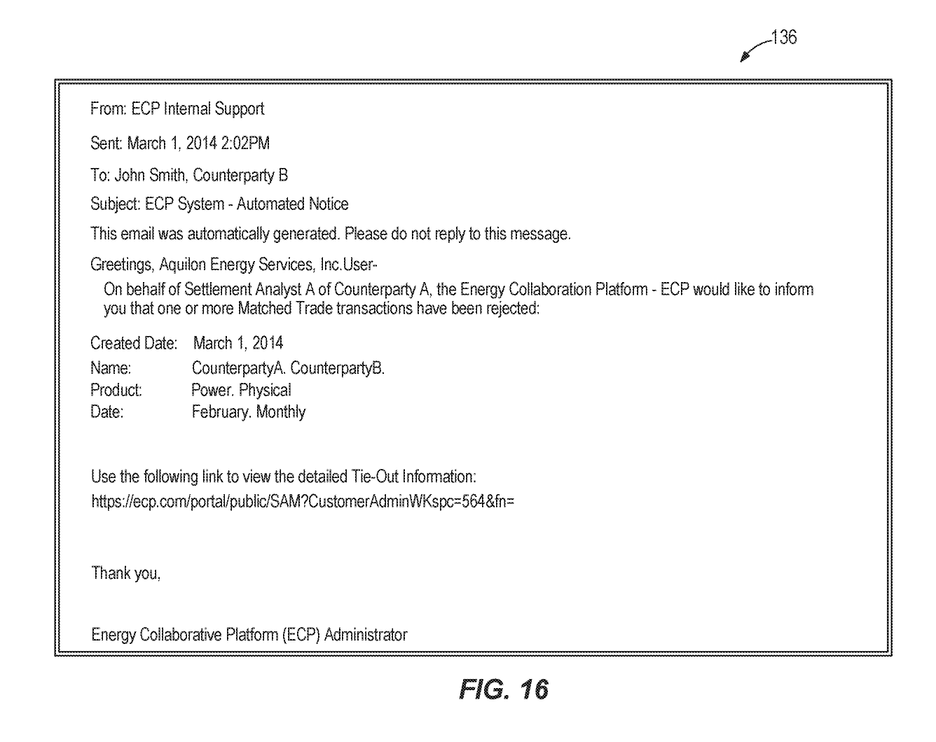

For example, the tie-out collaborate screen 127 presents a view of the matched transaction data of each participant's public and proprietary transactional data and enables either party to reject or approve the ECP matched transactions and enter transaction-specific public and proprietary comments. For example, either Settlement Analyst can override or reject an ECP-matched transaction by highlighting the matched trade transactions and selecting a “Reject Matched Trade” selection mechanism 128 in the tie-out collaborate screen 127 (see FIG. 15). In some embodiments, the rejecting Settlement Analyst can enter comments at the time of making rejection, which are available for review by the counterparty and explain the reason for the rejection. For example, as illustrated in FIG. 4A, if either Settlement Analyst rejects a matched transaction (at block 130), the ECP sets the status of the transaction to “Out-Trade” (at block 132), prompts the rejecting Settlement Analyst for comments (at block 134), and the ECP moves the rejected matched transaction to the out-trade transaction list section of the collaborative tie—out period workspace. The ECP can also send a reject matched trade notification 136 (see FIG. 16) to one or both parties informing the party that the matched transaction was rejected. In some embodiments, the notification 136 can include comments from the rejecting party. The notification 136 can be in the form of an ECP on-line alert, an email, or another communication form.

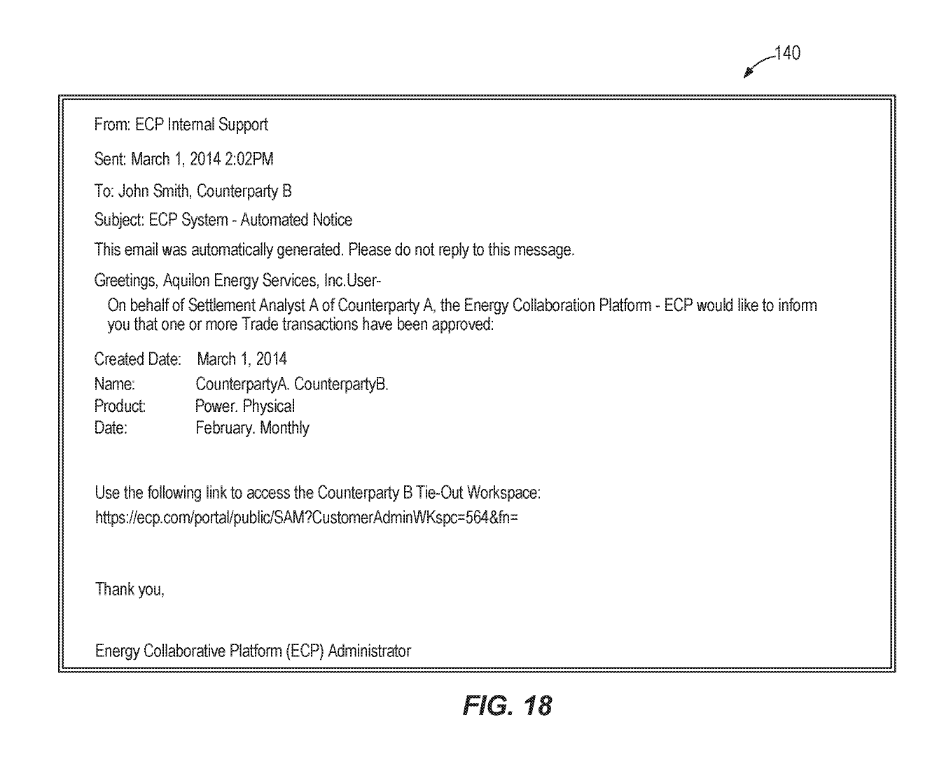

When the ECP generates an out-trade transaction, a Settlement Analyst can also decide to accept the bilateral counterparty's view of the transaction by selecting the “Approve Trade” selection mechanism 138 (see FIG. 17). Selecting the selection mechanism 138 invokes the transaction maintenance module 23 to update the transaction as “matched.” The ECP can also sends an approve trade notification 140 (see FIG. 18) to one or both parties notifying the party that the out-trade transaction has been set to “Matched.” In some embodiments, accepting another party's view of a transaction causes the ECP to adjust the invoice details without adjusting the underlying transaction details. In other embodiments, accepting another party's view of a transaction results in an update the transaction details.

The ECP calculates and presents transaction totals (amounts and volume) for the matched transaction list to both parties. The ECP can also calculate and present a net amount due to the payee (i.e., the bilateral counterparty to whom a payment is due). In some embodiments, after all transactions for the tie-out period are matched (at block 150), both participants accept and approve the collaborative tie-out period by selecting a “Close Tie-Out” selection mechanism 152 in the tie-out collaborate screen 127 (at block 153). In other embodiments, even if not all of the transaction for the tie-period are matched, the ECP can allow the participants to approve the collaborative tie-out period and the ECP can automatically process each out-trade transaction included in the tie-out and creates a dispute that is processed during the dispute management process 68. Upon selecting the “Close Tie-Out” selection mechanism 152, the ECP designates the tie-out period as “invoice ready.” In some embodiments, the participants continue to process transactions and reject matched transactions until both parties agree to all transactions or until a user configurable invoice date occurs (at block 155), at which time ECP automatically designates the tie-out period as “invoice ready” and automatically processes each out-trade transaction included in the tie-out and creates a dispute that is processed during the dispute management process 68.

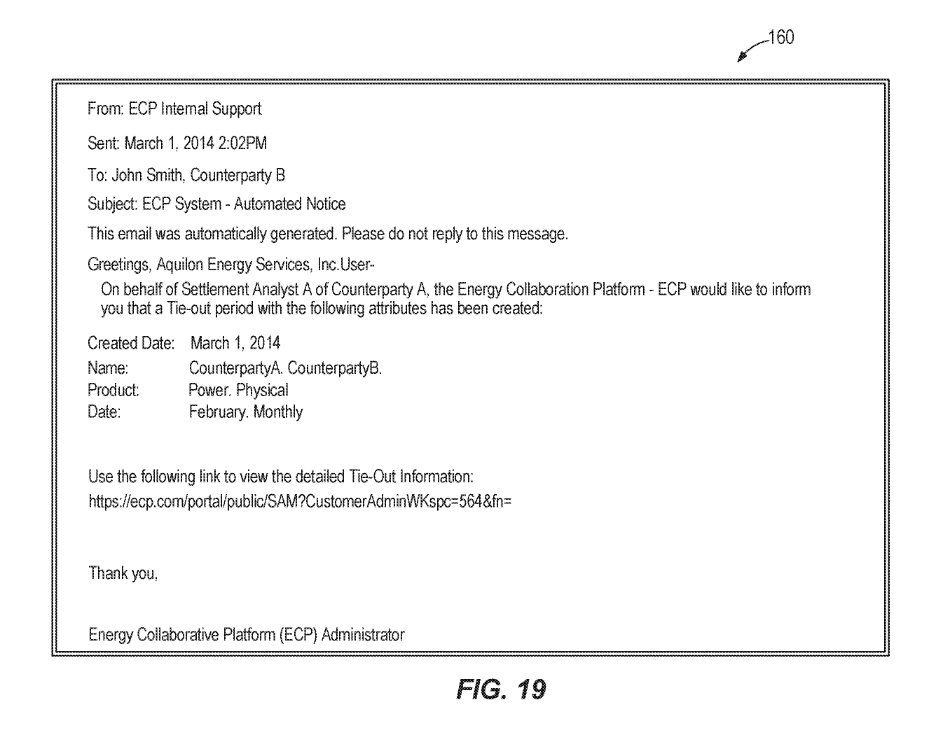

When the tie-out period is “invoice ready,” the ECP sets the status of each approved matched transaction as “Eligible for Invoicing” (at block 156). The ECP also sends a tie-out ready for invoicing notifications 160 (see FIG. 19) to both participants (at block 157). The notification 160 informs the participants that the tie-out period is “invoice ready” and the invoicing process 57 is ready to begin.

Returning to block 122 illustrated in FIG. 4A, if the bilateral transaction real-time matching algorithm does not match a transaction from Participant A's transaction list with a transaction from Participant B's transaction tie-out period list, the ECP adds the transaction to the out-trade transaction list, which presents a shared view of a list of transactions for which there is contradictory or otherwise inconsistent transaction attribute(s) between the two counterparties' transaction data. The ECP also sets the status of these transactions to “Out-Trade” (at block 125). Using the on-line information in the tie-out collaborate screen 127 illustrated in FIG. 14, the counterparties interactively work to resolve the transactions on the out-trade transaction tie-out period list (at block 162). For example, the ECP provides the ability to attach private and public notes to transaction data by selecting a “add notes” selection mechanism 164 (see FIG. 17). Therefore, the parties can use the notes to maintain an audit log of the resolution activities. The ECP also calculates and presents transaction totals (amounts and volume) for the out-trade transaction tie-out period list. If the parties can reconcile an out-trade (at block 166), the parties (e.g., the Settlement Analysis) notify the respective Risks Analysts to enter revised transaction details in the respective transaction systems of record 51 (at block 168). The ECP can also notify the participants (e.g., Risk Analysts of each participant) to update the revised transaction details in their respective transaction system of record 51 and add comments to the transaction in the ECP (at block 170). The parties update the transactional information in the transaction system of record 51 (at block 172), and, after the transaction data is revised the transaction is re-imported from the transaction system of record 51 (e.g., automatically via the interfaces module 22 or manually via the transaction maintenance module 23) (at block 174 and as described above with respect to blocks 100 and 112 in FIG. 3). The revised data can then be loaded and selected into the tie-out period workspace (see FIG. 3) at which time the ECP includes the transaction in the real-time match process (at block 120 in FIG. 4A).

For example, Settlement Analyst A can select several hourly power trade transactions that the trade matching engine 28 set to “Out-Trade” because one or more data attributes of each trade provided by counterparty B, for example the volume or price information, did not match the same data attribute information provided by counterparty A for the same trade. After revising transaction details for the out-trades in party's A transaction system of record 51, Settlement Analyst A can select the “Request Trade Revision” selection mechanism 176 (see FIG. 17) for the selected transactions. Selecting the selection mechanism 176 causes the ECP to update the selected trades using the transaction maintenance module 23. The revised information is made available for viewing by both counterparties in the tie-out collaborate screen 127 illustrated in FIG. 14.

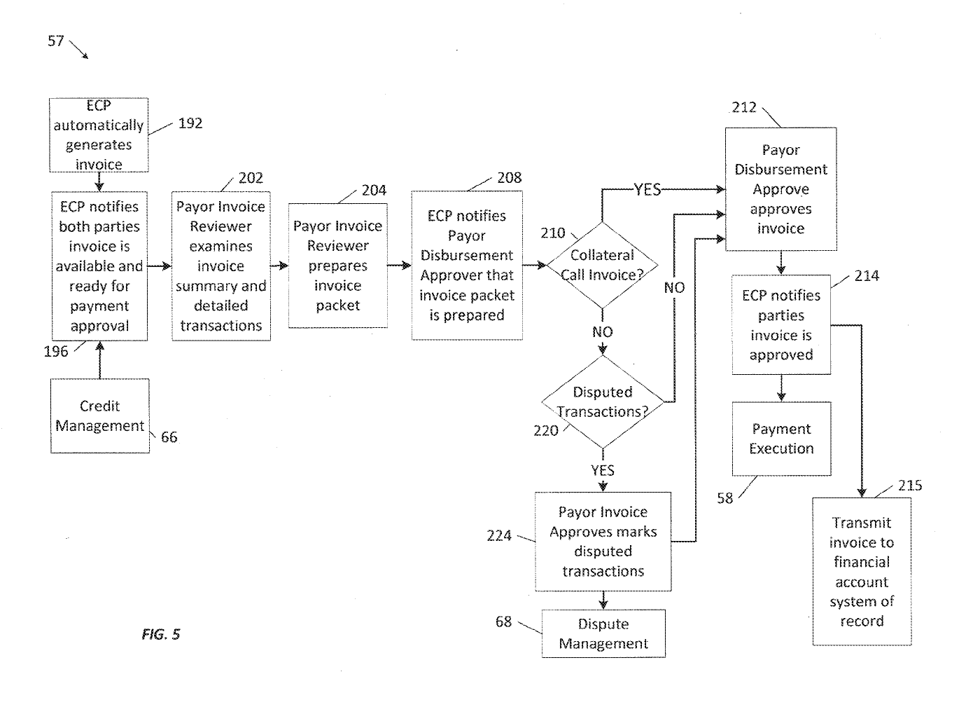

If an out-trade cannot be reconciled and matched during this tie-out period (at block 166), a dispute for the transaction can be established (at block 180). In particular, a party can set the transaction as “disputed” by selecting a “Dispute Trade” selection mechanism 182 (see FIG. 17 for out-trade transactions and see FIG. 15 for matched transactions). When a dispute is established, the ECP designates the disputed transaction as “Disputed” for a tie-out period. As described below with respect to the invoicing process illustrated in FIG. 5, in some embodiments, transactions marked as “Disputed” can be included in the invoicing process 57. However, in other embodiments, “Disputed” transactions can be excluded from the invoicing process 57.

Accordingly, as illustrated in FIGS. 4A and 4B, the counterparties can jointly review matching results and out-trades through the ECP and can independently approve or reject ECP-matched transactions. The counterparties can also review unmatched transactions, or out-trades, on-line and collaboratively work to resolve inconsistencies. In some embodiments, on the date of invoice issue all transactions are included in the ECP-created invoice for the defined tie-out period. Disputed transaction included in an invoice will often not be paid by the counterparty until the dispute is resolved, which may result in partial payment of invoices containing disputes. Accordingly, based on configuration information established using the counterparty administration module 14 and the master agreement management module 16, the ECP performs the on-line collaborative tie-out process 56 in an automated, partially automated, or manual fashion.

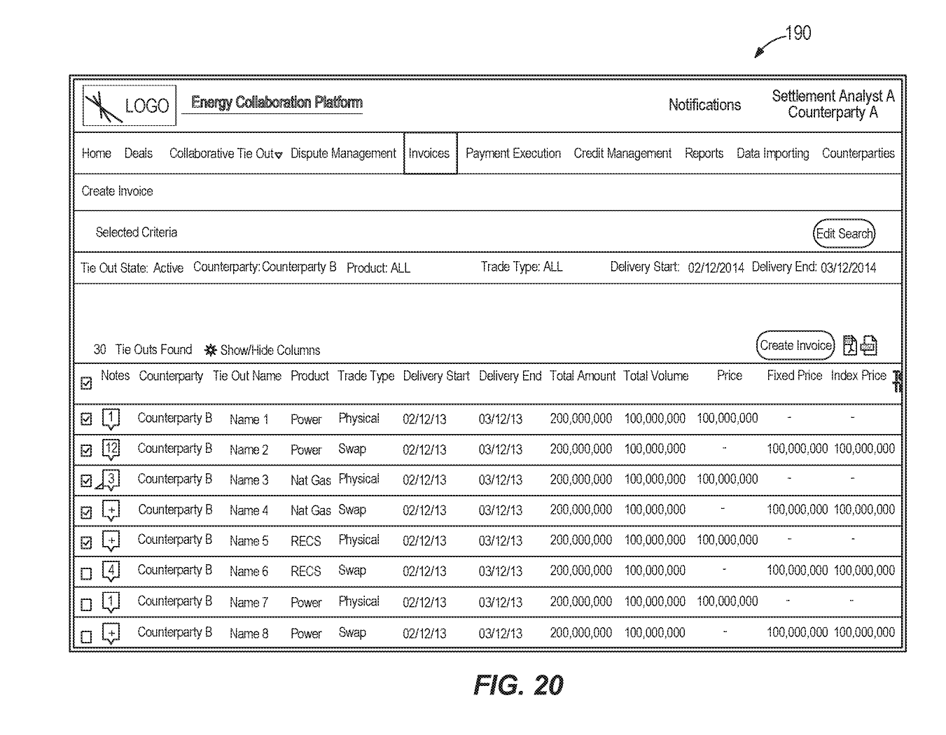

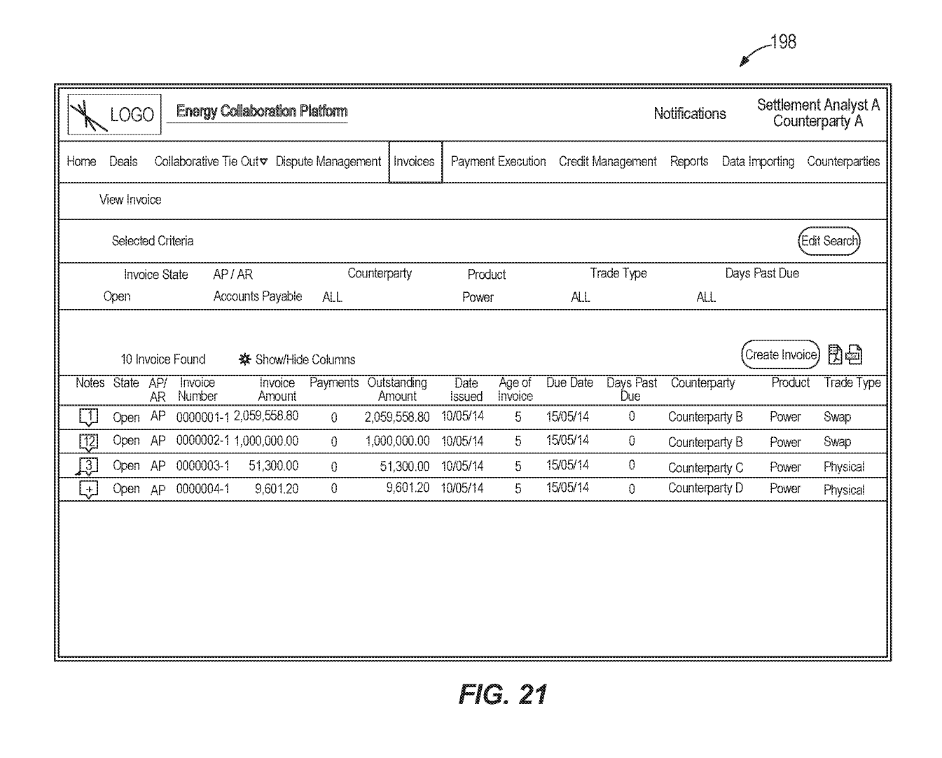

FIG. 5 illustrates the invoicing process 57 in more detail. As described above, during the invoicing process 57, the parties can accept and close the tie-out period during the collaborative tie-out process 56, which makes the invoice ready for creation and sets the transactions as “Invoice Ready,” which may result in a “net” invoice between counterparties. In some embodiments, the ECP is configured such that a specific participant always creates the invoice (Participant A or Participant B) or a specific invoice role creates the invoice (payor or payee). For example, a party can select one or more tie-outs that are marked as “Invoice Ready” for an invoice through a create invoice screen 190 as illustrated in FIG. 20. In some embodiments, collateral call invoice generating the credit management process 66 are also selected for invoice processing from the view invoices screen in FIG. 21. In other embodiments, the ECP automatically creates the invoice upon completion and finalization of the collaborative tie-out process 56. The ECP can use information managed by the master agreement management module 16 to determine if an “invoice ready” tie-out is automatically invoiced by the ECP. The ECP can also call the master agreement management module 16 to access counterparty configurable invoice settings. The ECP applies these settings when automatically generating the invoice. Automatically generating an invoice can include generating a complete invoice and/or generating invoice information (e.g., a line item file) that the ECP transmits to a party's invoicing system (e.g., through the interfaces module 22). In some embodiments (e.g., based on invoice settings), the tie-out may contain disputed transactions when the invoice is generated by the ECP. Accordingly, based on configuration information established using the counterparty administration module 14 and the master agreement management module 16, the ECP can perform the invoicing process 57 in an automated, partially automated, or manual fashion.

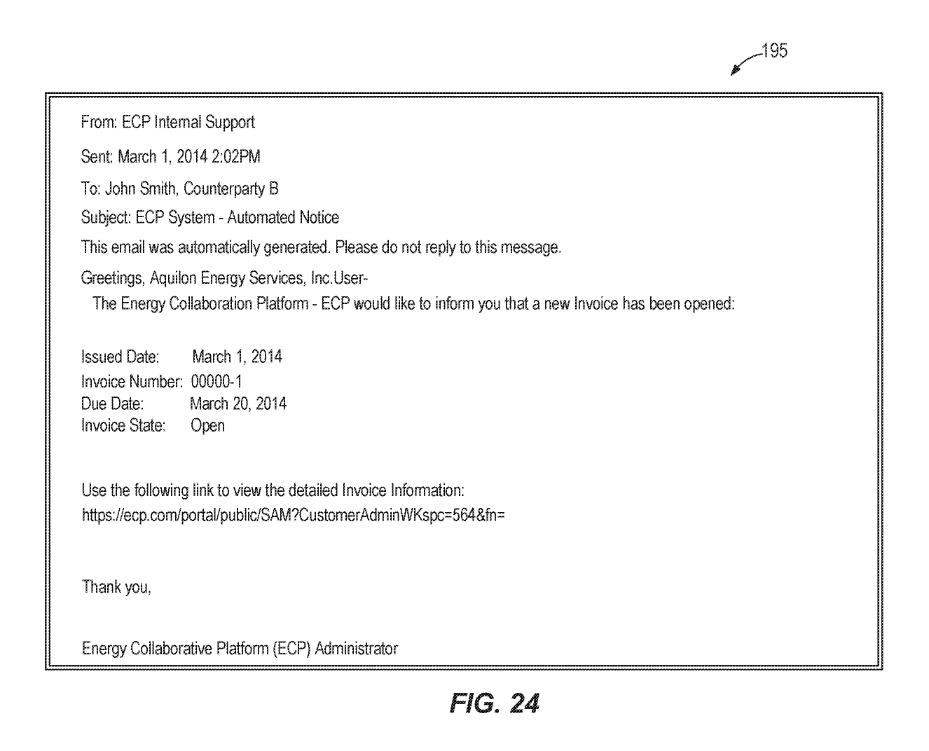

Upon either manual or automatic execution, the ECP creates an invoice that includes the transactions for a specific bilateral counterparty and defined tie-out period (at block 192 in FIG. 5). The transactions represented in the invoice can include matched transactions and out-trade transactions. Upon creation of an invoice, the ECP automatically generates an open invoice notification 195 (see FIG. 24) that notifies both participants that the invoice for the tie-out period is available and ready for the payment execution process (at block 196). The ECP also assigns the created invoice a status of “open.” The ECP can also be configured to generate invoice and invoice line item transactions and electronically submit the information to each parties' financial system of record 52 (e.g., through the interfaces module 22).

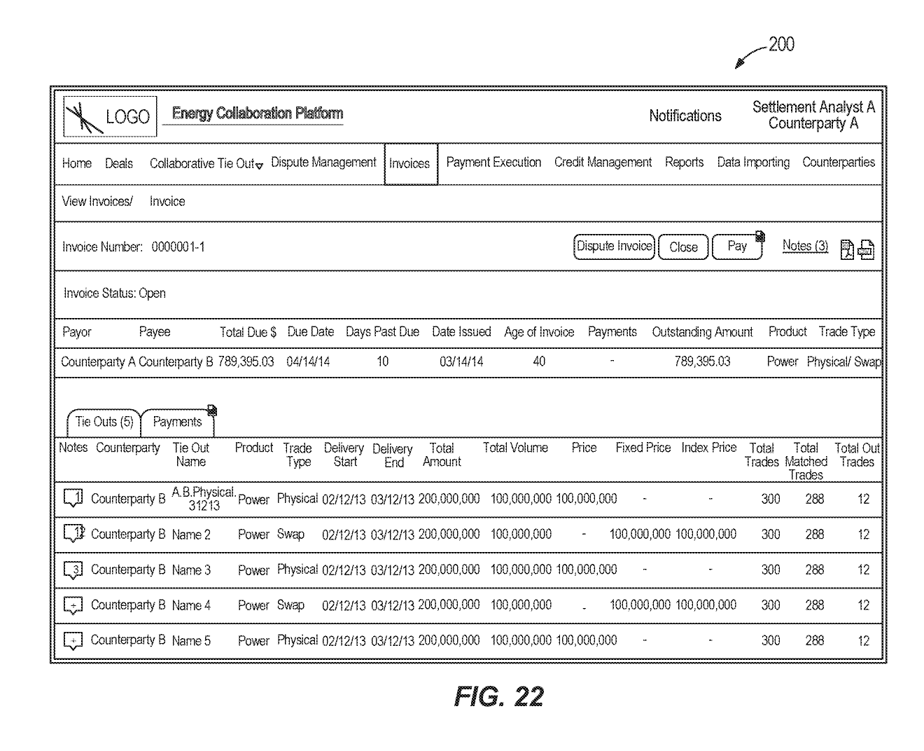

Both parties can access the invoice information through a view invoices screen 198 (see FIG. 21). The invoice information can include invoice totals, data, product, trade type, and notes associated with the invoice. The invoice information can also be presented in an invoice collaborate screen 200 (see FIG. 22) that includes summary transaction details, calculated invoice transaction line item amounts, and totals based on the transactions included on the invoice.

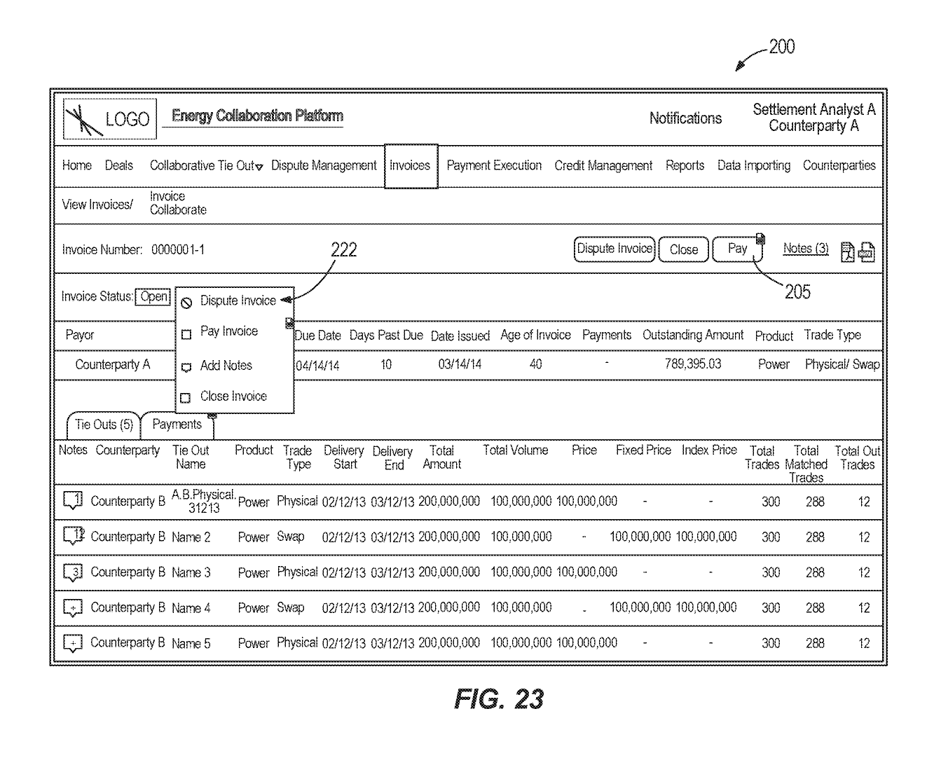

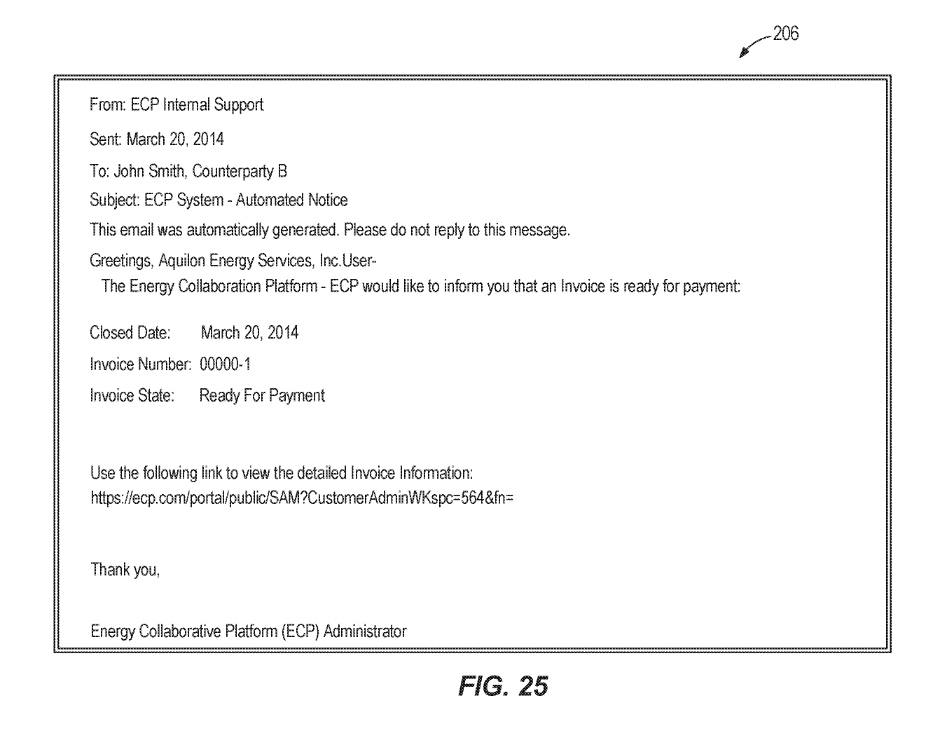

The payor (e.g., an Invoice Reviewer) can examine the invoice summary and the detailed transactions in the invoice collaborate screen 200 (at block 202). The payor can also prepare the invoice for the tie-out period, such as by attaching supporting documents via the document management module 44 and indicating any potential disputed transactions (at block 204). The payor can then select a “Pay” selection mechanism 205 (see FIG. 23) to initiate payment on the invoice. Upon processing of the invoice, the ECP can notify a Payor Disbursement Approver that the Payor Invoice Reviewer processed the invoice and the invoice is “payment ready” by generating a payment ready invoice notification 206 as illustrated in FIG. 25 (at block 208). Similarly, if an invoice is for a collateral call (at block 210), the payor (e.g., the Payor Disbursement Approver) can select the “Pay” selection mechanism 204 (see FIG. 23) to initiate payment (at block 212). In response, the ECP changes the status of the invoice to “payment ready” and notifies both the payee and the payor that the invoice is approved and the payment is ready for execution (e.g., by generating a payment ready invoice notification 206 as illustrated in FIG. 25) (at block 214). The ECP can also be configured to transmit the invoice (e.g., including detailed transaction lines) to the financial accounting system of record 52 of one or both parties (at block 215). In some embodiments, the ECP sends periodic reminder notifications of open tie-out invoices and open collateral call invoices.

In some embodiments, if there is a disputed transaction within invoice information (at block 220), a party (e.g., the Payor Disbursement Approver) can select the disputed transaction and select a “Request Trade Revision” selection mechanism 222 (see FIG. 23) (at block 224). The party can also enter comments clarifying the reasons the transaction is being disputed. Disputed transactions are processed during the dispute management process 68 described below. In some embodiments, invoices can be paid in full after the payment execution process 58 and “disputed” transactions can be resolved by the counterparties after payment is made.

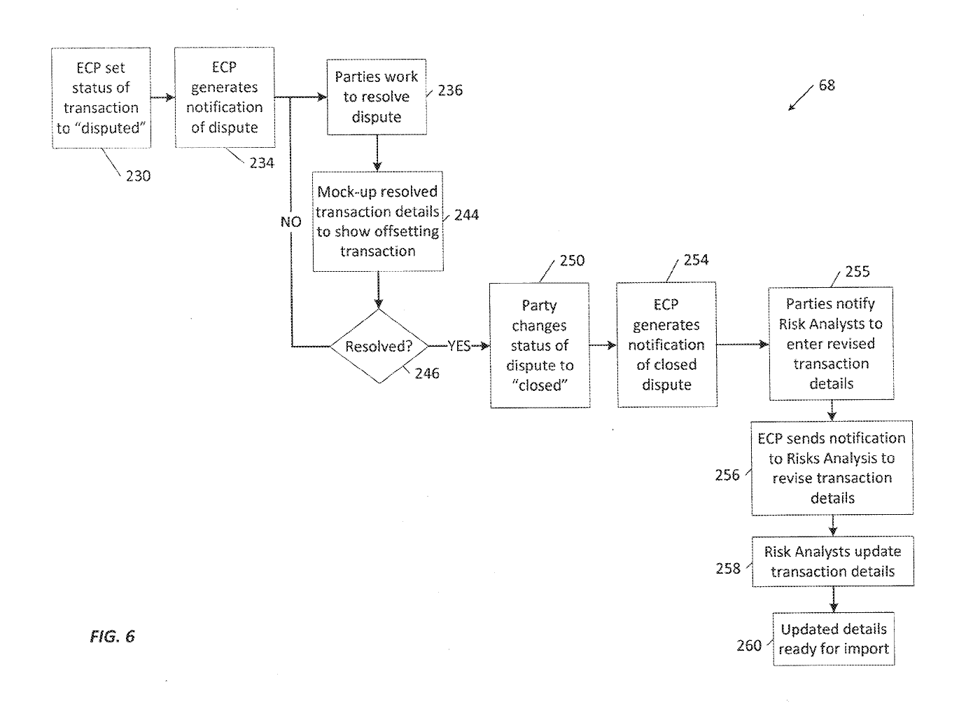

FIG. 6 illustrates the dispute management process 68 in more detail. The dispute management process 68 includes creating and managing a disputed transaction. As described above, a participant can identify a disputed transaction during the collaborative tie-out process 56 and during the invoicing process 57. In both processes, after a participant sets a transaction as disputed (e.g., by selecting the “Dispute Trade” selection mechanism 182 in FIG. 15 for matched trades, by selecting the “Dispute Trade” selection mechanism 182 in FIG. 17 for out-trades, or by selecting the “Request Trade Revision” selection mechanism 222 in FIG. 23 for invoices), the ECP sets the status of the transaction to “disputed” (at block 230).

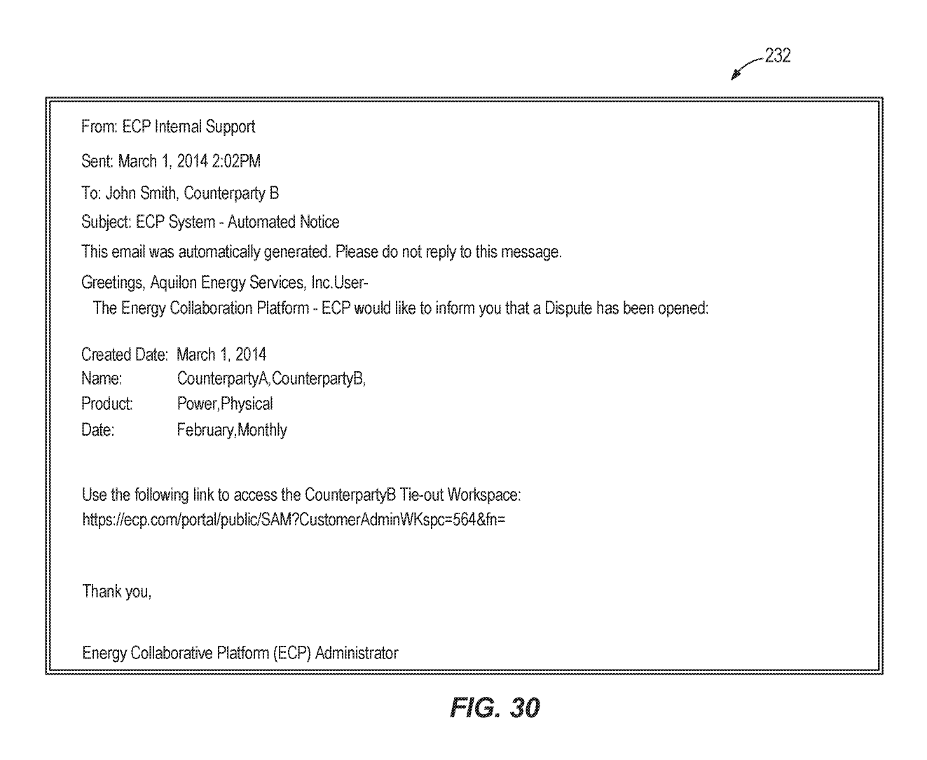

The ECP can also generate an open dispute notification 232 to both participants as illustrated in FIG. 30 (at block 234). The two parties (e.g., the Settlement Analysts) then use the ECP to work interactively to perform to resolve the dispute (at block 236). For example, the parties can include recording both public and proprietary notes associated with the dispute resolution actions to maintain a dispute audit log and requesting trade revisions.

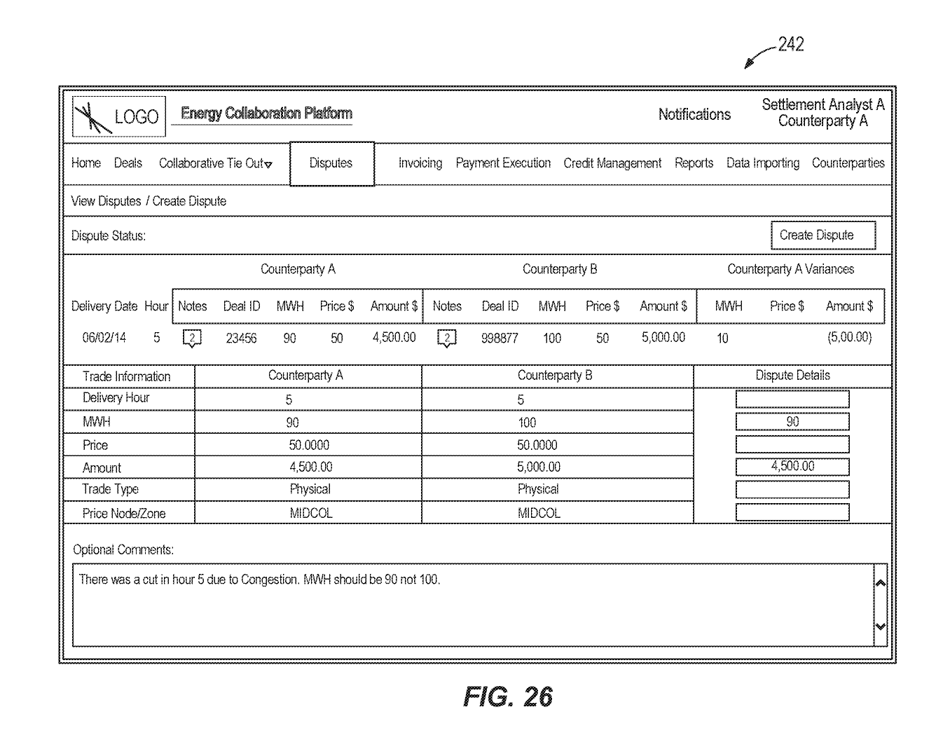

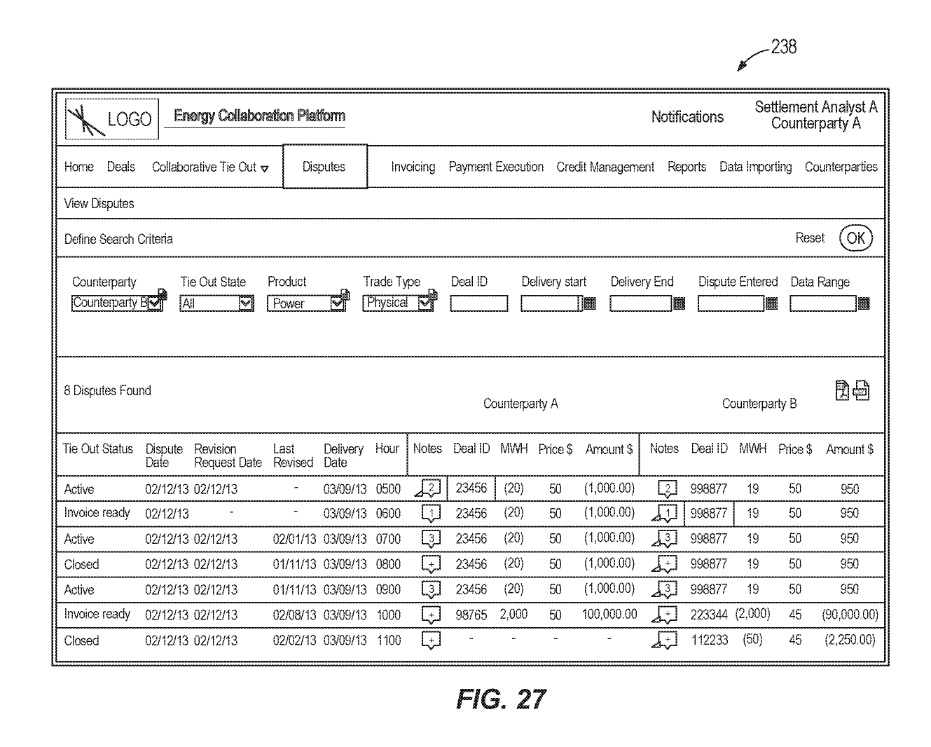

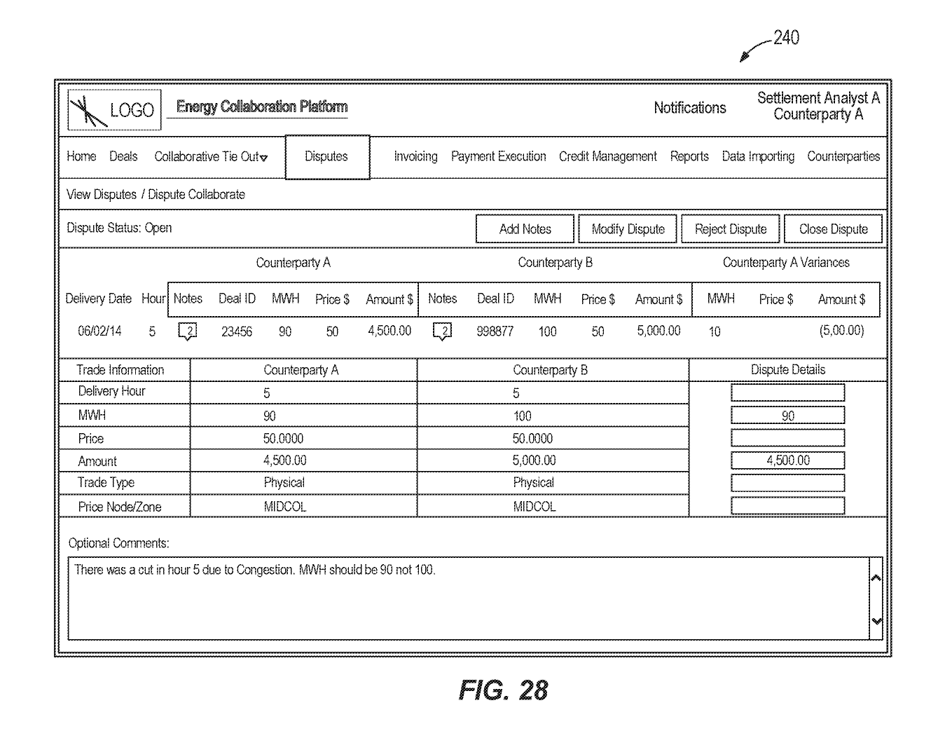

For example, the ECP presents each participant a view of disputed transactions with one or more counterparties in a view disputes screen 238 illustrated in FIG. 27. The ECP also allows two bilateral counterparties to view disputed transactional data in a common, shared workspace in a dispute collaborate screen 240 as illustrated in FIG. 28. The collaborative workspace illustrated in FIG. 28 includes a proprietary information section that presents proprietary data about the disputed transactions that are not presented in the shared section. The proprietary information is only viewable by the owning participant. For each dispute, a disputing participant can enter additional dispute details using a create dispute screen 242 as illustrated in FIG. 26. The create dispute screen 242 can call the transaction maintenance module 23 to update the dispute based on the details. In some embodiments, a party can use the ECP to mock-up resolved transaction details to show offsetting transactions (at block 244).

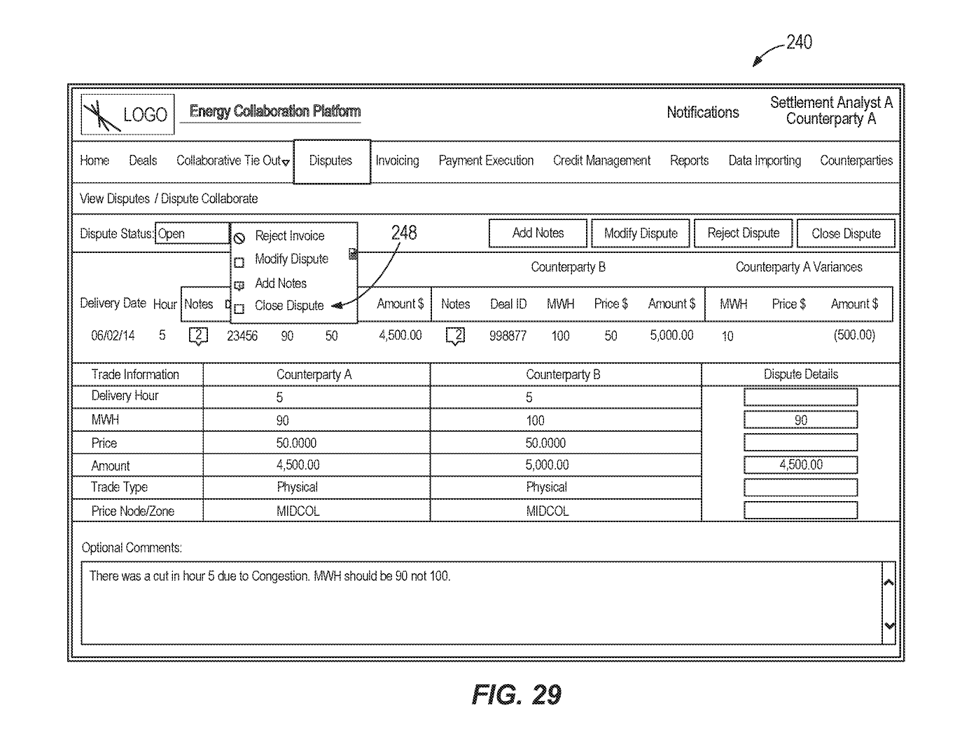

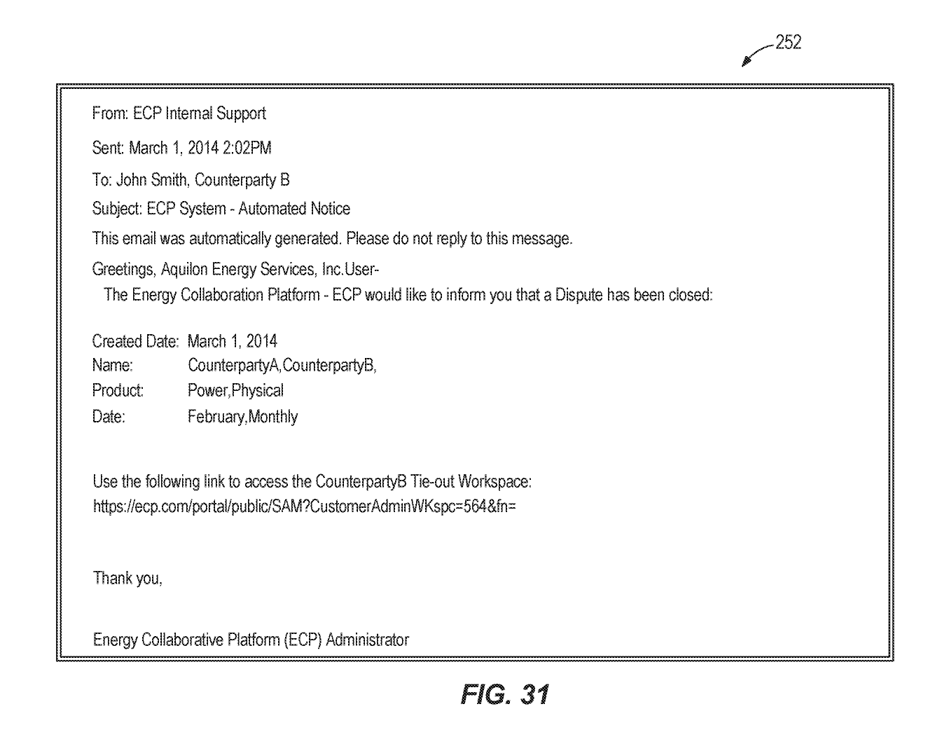

If the parties agree to resolving a disputed transaction (at block 246), one or both parties (e.g., the disputing participant) can select a “Close Dispute” selection mechanism 248 (see FIG. 29), which calls the transaction maintenance module 23 to update the dispute status as “closed” (at block 250). In some embodiments, when closing a dispute, a participant can enter additional comments on the resolution including an off-setting transaction identifier (see FIG. 29). Upon closing a dispute, the ECP also automatically generates a closed dispute notification 252 (see FIG. 31), which is sent to both participants and informs the participants that the dispute has been closed (at block 254). The Settlement Analysis of one or both parties can also notify respective Risk Analysts to enter revised transaction details in the respective transaction systems of record (at block 255). In some embodiments, the ECP also notifies the parties (e.g., the respective Risk Analysts) to enter the revised transaction details in their respective transactions systems of record 51 and, optionally, add clarifying comments to the transaction record to maintain a dispute audit log (at block 256). The Risk Analysts can review dispute information in the view disputes screen 238 (see FIG. 27) and the dispute collaborate screen 240 (see FIG. 28). After reviewing the information, the Risk Analysts can update the transactional information in the transaction systems of record 51 (at block 258). After the transaction data is revised, the transaction is re-imported from the transaction system of record 51 (e.g., via the interfaces module 22 or manually via the view trades screen (see FIG. 12)) (at block 260). The data can then be selected into the appropriate tie-out period by performing the add trades action in the tie-out collaborate screen 127 (see FIG. 14), which causes the ECP to include the transaction in the tie-out and associated matching process.

If a disputed transaction is not resolved (at block 246), the parties (e.g., the Settlement Analysts) can continue reviewing transactional information to reconcile their differences. The ECP can be configured to send periodic reminder notifications of open disputes.

Accordingly, based on configuration information established using the counterparty administration module 14 and the master agreement management module 16, the ECP can perform the dispute management process 68 in an automated, partially automated, or manual fashion.

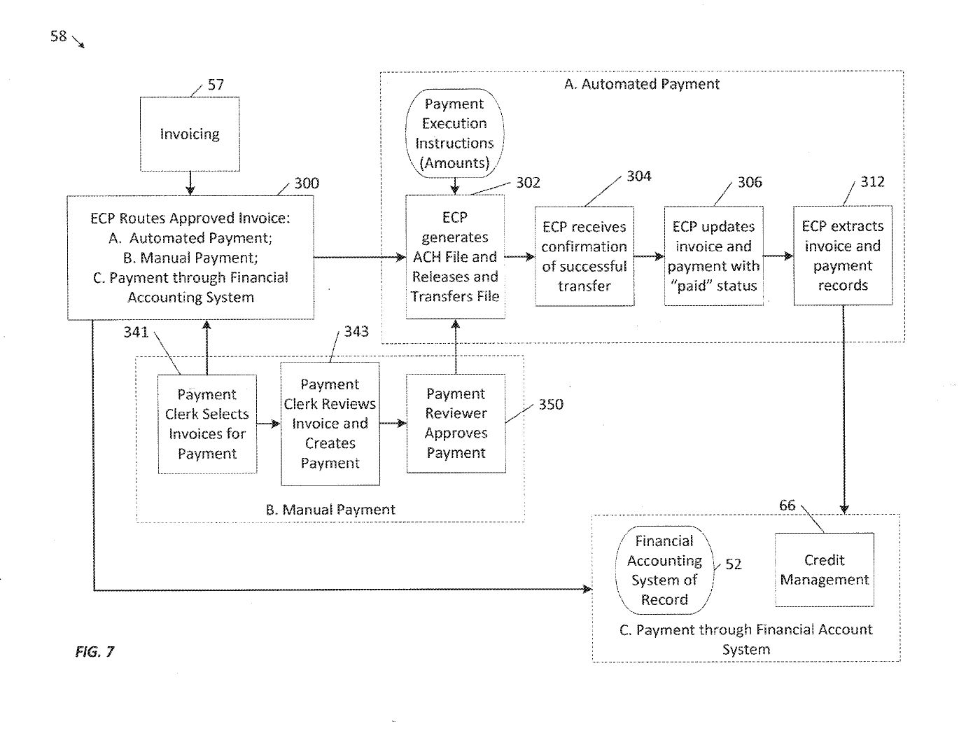

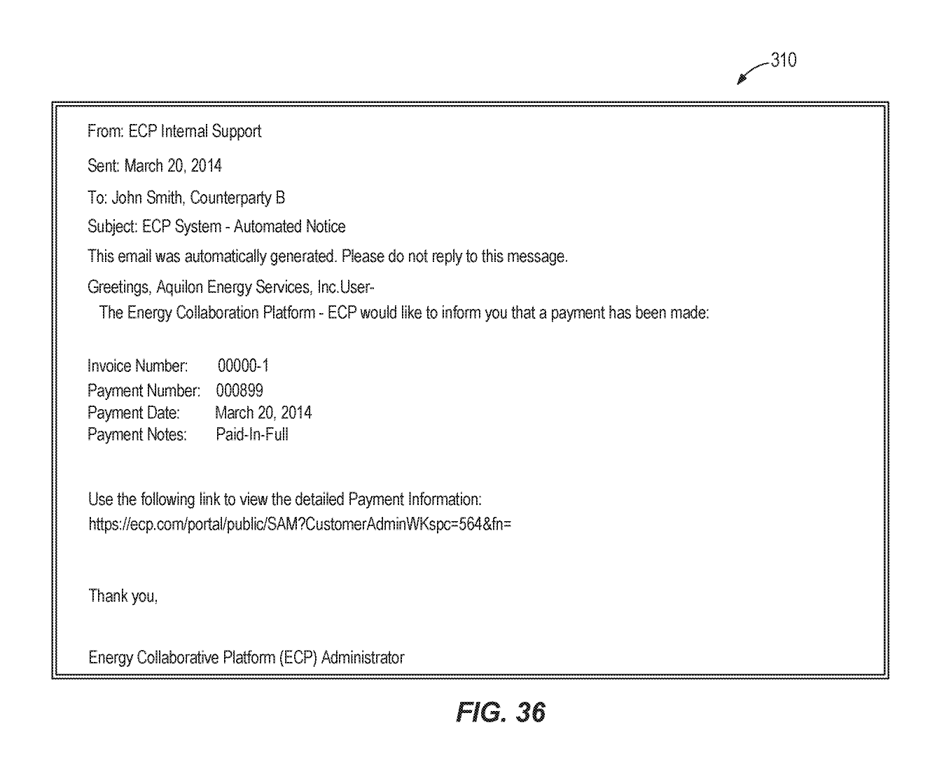

FIG. 7 illustrates the payment execution process 58 in more detail. Upon approval of the invoice (e.g., see FIG. 5), the ECP can be configured to process payments in either an automated payment workflow process, a manual payment workflow process, or a bilateral financial accounting system interface (at block 300). For example, in the automated payment workflow of FIG. 7, the ECP can be configured to automatically generate an ACH file that includes counterparty bank account information (at block 302). The ECP can access the counterparty administration module 14 to retrieve payment instructions and other information for a particular party. The ECP then calls the payment module 46 which invokes the interfaces module 22 to transfer the ACH file to the appropriate counterparty's bank for execution. Following the ACH service executing the funds transfer, the ECP receives confirmation of the successful transfer of funds (at block 304) and invokes the payment module 46, which calls the transaction maintenance module 23 to change the status of the payment to “paid” and the status of the appropriate invoice(s) to “closed” (at block 306). The ECP also generates a payment notification 310 as illustrated in FIG. 36 and transmits the notification 310 to both parties notifying them that successful funds transfer between the parties has completed. The ECP can also extract records of both the payment and the invoice activity and use the interfaces module 22 to update both of the two bilateral transaction counterparties' financial accounting systems of record 52 with payment information (at block 312). The payment information can include but is not limited to invoice, invoice line-items, and payment journal entries. The ECP can also export these payment records into a party's credit management system via the interfaces module 22. In some embodiments, the ECP can be configured to manually present approved invoices to a Payment Clerk for inclusion in a payment via the payment module 46. After the payment has been created by the Payment Clerk, the payment details can be reviewed and approved by a Payment Reviewer via the payment module 46. Thereafter, the payment module 46 invokes the automated payment workflow of FIG. 7 to complete processing of the ACH payments.

In the bilateral financial accounting system workflow, the payment module 46 prepares an interface file containing the payment information for one or both counterparties and accesses the interfaces module 22 to update counterparties' financial accounting systems of record 52 with payment information. The payment information can include but is not limited to invoice information and invoice line-items. Payment is then made by the counterparty using their existing financial payment system.

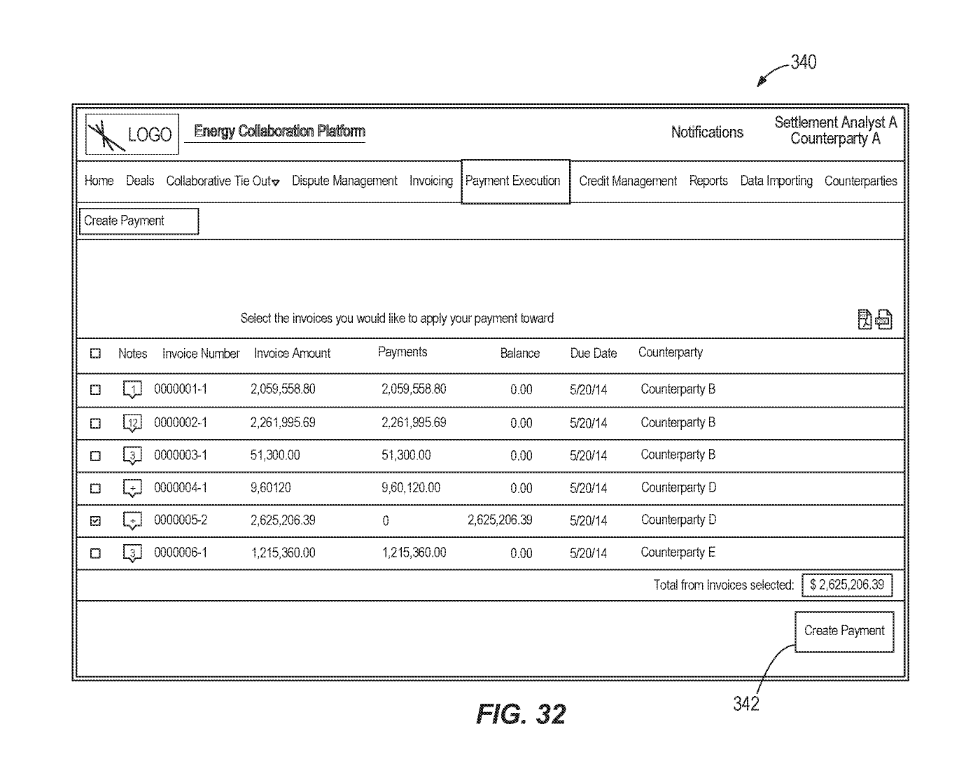

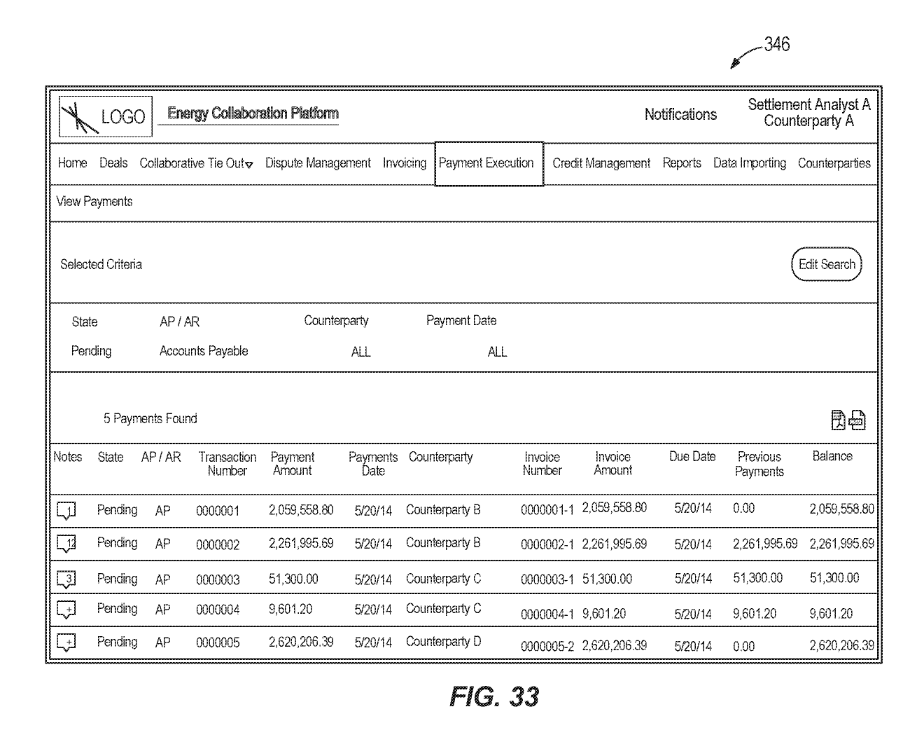

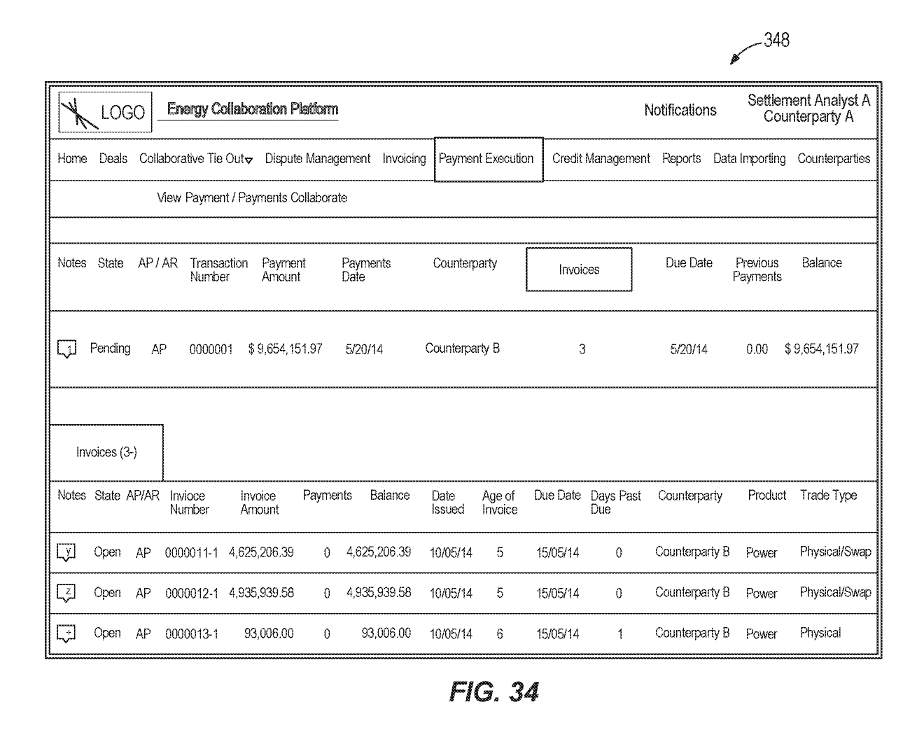

In the manual payment workflow, a Payment Clerk accesses the invoices eligible for invoicing through a create payment screen 340 (see FIG. 32) (at block 341). The Payment Clerk then selects one or more eligible invoices for a counterparty to be included in a single payment and selects the “Create Payment” selection mechanism 342 (e.g., resulting in a “net payment” to the bilateral counterparty) (at block 343). The payment module 46 creates the payment with a status of “pending” and schedules the payment based on the information contained in the invoices. The Payment Clerk can view payments (both to be made to a party's accounts payable (“A/P”) and to be received through a party's accounts receivable (“A/R”)) through a view payments screen 346 as illustrated in FIG. 33. A Payment Clerk can select a payment illustrated in the view payments screen 346 to view the detailed information regarding the payment, such as the invoices associated with the payment. These details can be presented in a payment collaborate screen 348 as illustrated in FIG. 34.

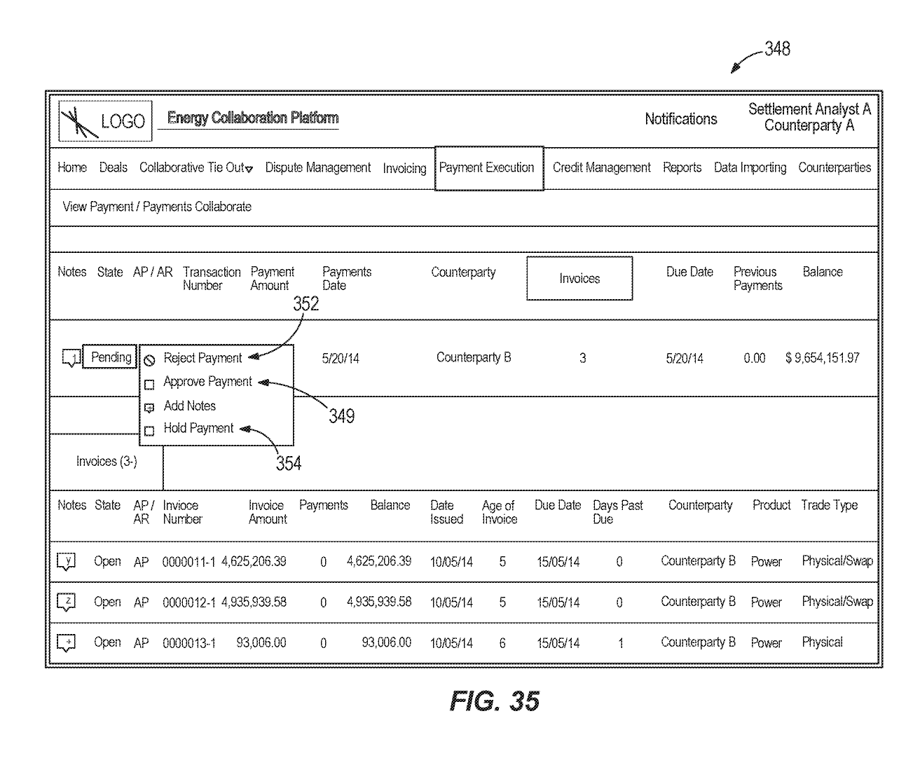

In some embodiments, a payment with a “pending” status must be approved by a second user or role of the party with the authority to approve payments as determined by the user administration module 10 (e.g., a Payment Reviewer). The Payment Reviewer can access “pending” payments and select an “Approve Payment” selection mechanism 349 (see FIG. 35) to approve a pending payment (at block 350). The ECP can then process each approved payment using the automated payment workflow illustrated in FIG. 7.

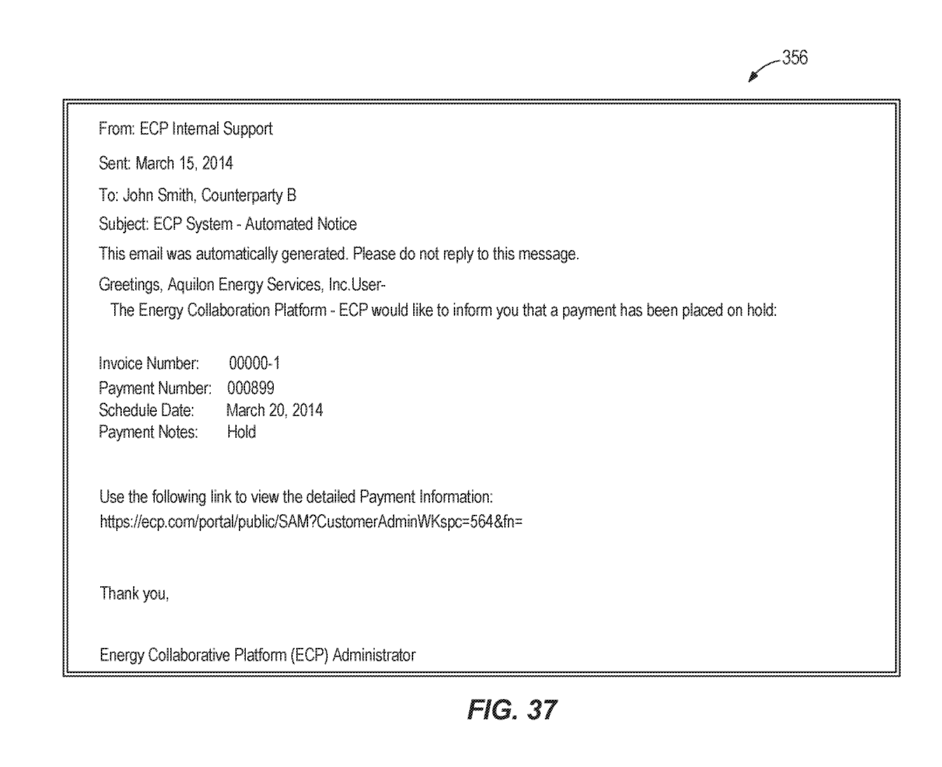

In some embodiments, in addition to approval, a Payment Reviewer can reject a payment by selecting a “Reject Payment” selection mechanism 352 illustrated in FIG. 35. Upon selecting the “Reject Payment” selection mechanism 352, the ECP calls the payment module 46 to update the payment as being “rejected.” In some embodiments, the ECP also prompts the Payment Reviewer rejecting the payment to enter an explanation and the ECP can add this information to the payment as a note. The ECP can then route the rejected payment back to the Payment Clerk for additional processing and resubmittal to the Payment Reviewer. In some embodiments, the Payment Reviewer can also hold a payment by selecting a “Hold Payment” selection mechanism 354 illustrated in FIG. 35. If a payment is held, the ECP calls the payment module 46 to update the payment as being “held” and, optionally, prompts the Payment Reviewer to enter an explanation which is added to the payment as a note. The ECP can then generate a payment hold notification 356 for both parties as illustrated in FIG. 37.

Accordingly, based on configuration information established using the counterparty administration module 14 and the master agreement management module 16, the ECP can perform the payment execution process 58 in an automated, partially automated, or manual fashion.

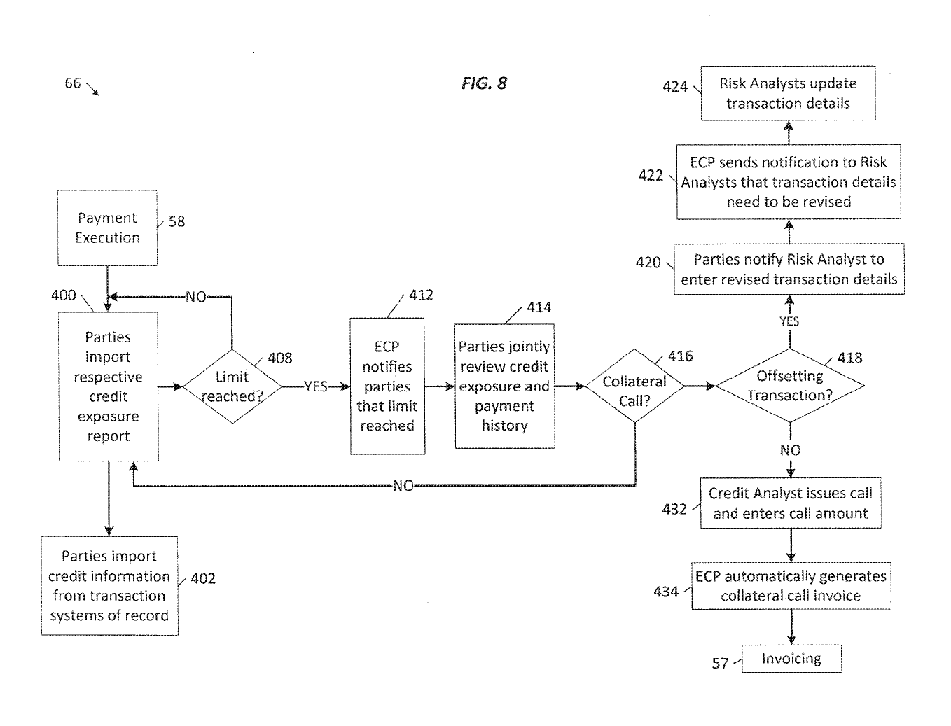

FIG. 8 illustrates the credit management process 66 in more detail. As part of the credit management process 66, the ECP updates (e.g., repeatedly or continuously) counterparty credit information during the transaction selection process 61, the collaborative tie-out process 56, the invoicing process 57, and/or the payment execution process 58 to enable a credit analyst to monitor a user-configurable credit margin threshold amount set for each individual bilateral counterparty (e.g., via the credit management module 36). For example, parties import respective credit exposure reports (e.g., current month plus forward positions) to the ECP (at block 400). As illustrated in FIG. 8, in some embodiments, credit information (e.g., credit threshold limits, forward credit exposure information, etc.) can optionally be imported to the ECP through the parties' respective transaction system of record 51 (at block 402).

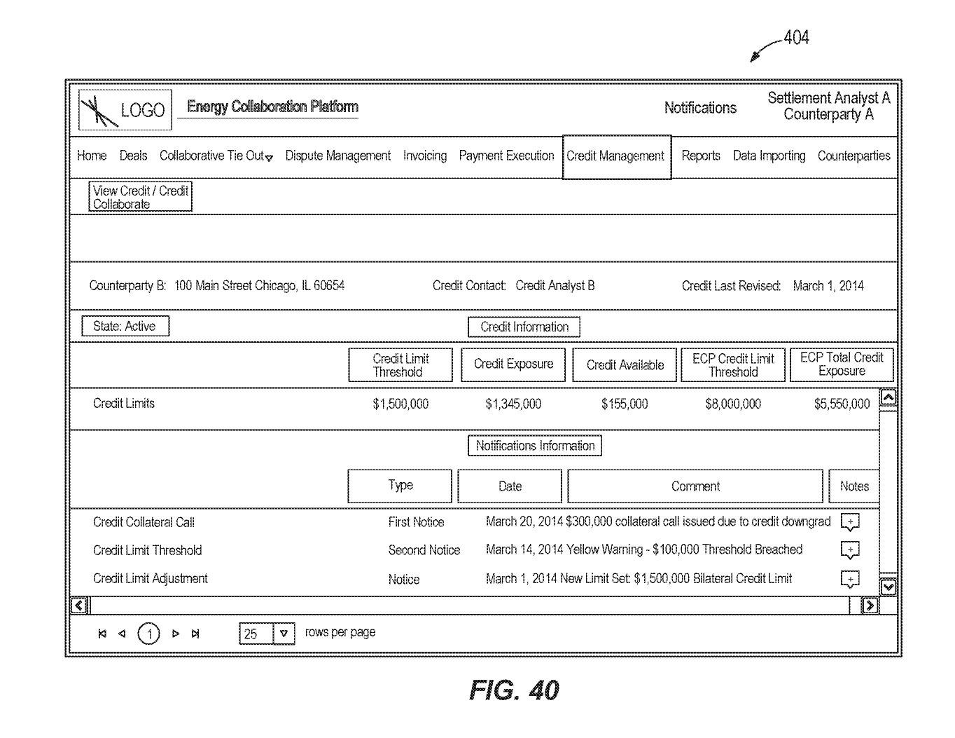

To manage credit information, the ECP can present the participants with a shared or collaborative view in a credit collaborate screen 404 as illustrated in FIG. 40. The credit collaborate screen 404 provides information regarding credit exposure between the bilateral counterparties and, in some embodiments, based on a configuration in the master agreement management module 16 and/or the total credit exposure between a party and all or a subset of counterparties using the ECP. A total credit exposure between a party and all other parties using the ECP can be referred to as ECP total credit exposure. The information included in the credit collaborate screen 404 enables bilateral counterparties to have a shared, common on-line workspace view of credit exposure information. In some embodiments, the credit collaborate screen 404 includes both shared information and a proprietary section that presents proprietary data about the credit information. The proprietary information is only viewable by the owning participant.

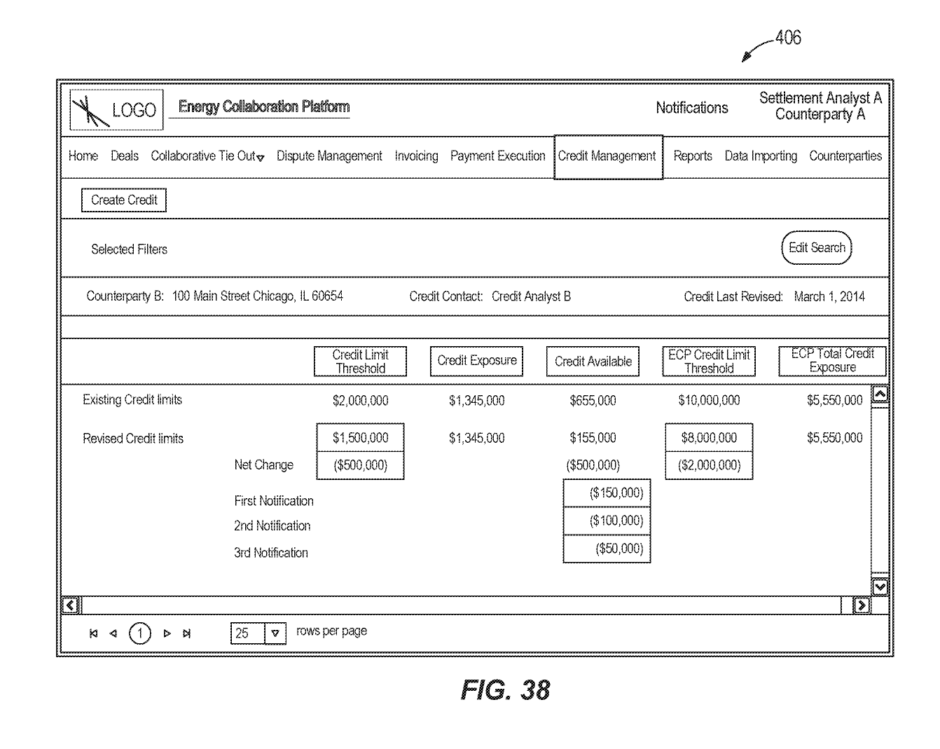

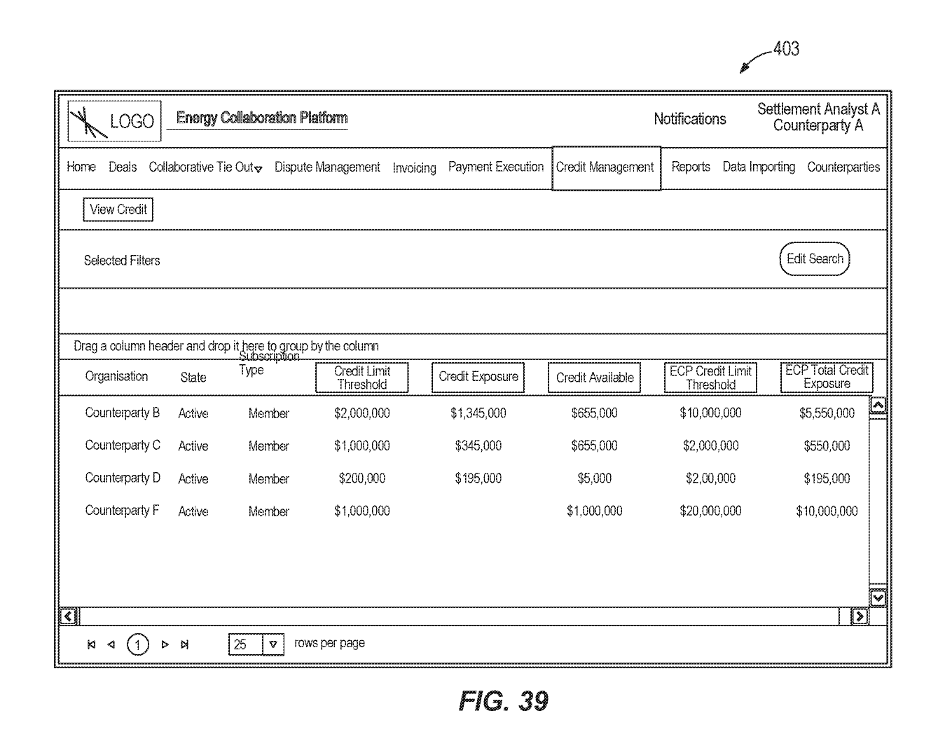

The ECP updates the credit exposure information presented in the credit collaborate screen 404 based on imported data from the parties and transaction processing during the transaction selection process 61, collaborative tie-out process 56, the invoicing process 57, the dispute management process 68, the invoicing process 57, and/or the payment execution process 58. For example, in some embodiments, the ECP continuously calculates the total credit amount between the counterparties by summing the expected financial exposure that exists in trade transactions, tie-outs, invoices, disputes and payments as if the counterparty were to immediately cease doing business. The ECP can also be configured to calculate, based on a configuration in the master agreement management module 16, the total credit amount between a single counterparty and all or a subset of counterparties 50 in the ECP by summing the expected financial exposure that exists across trade transactions, tie-outs, invoices, disputes and payments as if the counterparty were to immediately cease business with all participants 50. A party may also establish a credit threshold limit between two or more bilateral counterparties (e.g., entered using a create counterparty credit screen 406 as illustrated in FIG. 38). In some embodiments, a credit limit threshold can also be received from an automated interface by calling the interfaces module 22 to receive a file from an external risk management system such as an ETRM (e.g., at block 402 in FIG. 8). A party can view credit information for one or more parties using a view credit screen 403 as illustrated in FIG. 39.

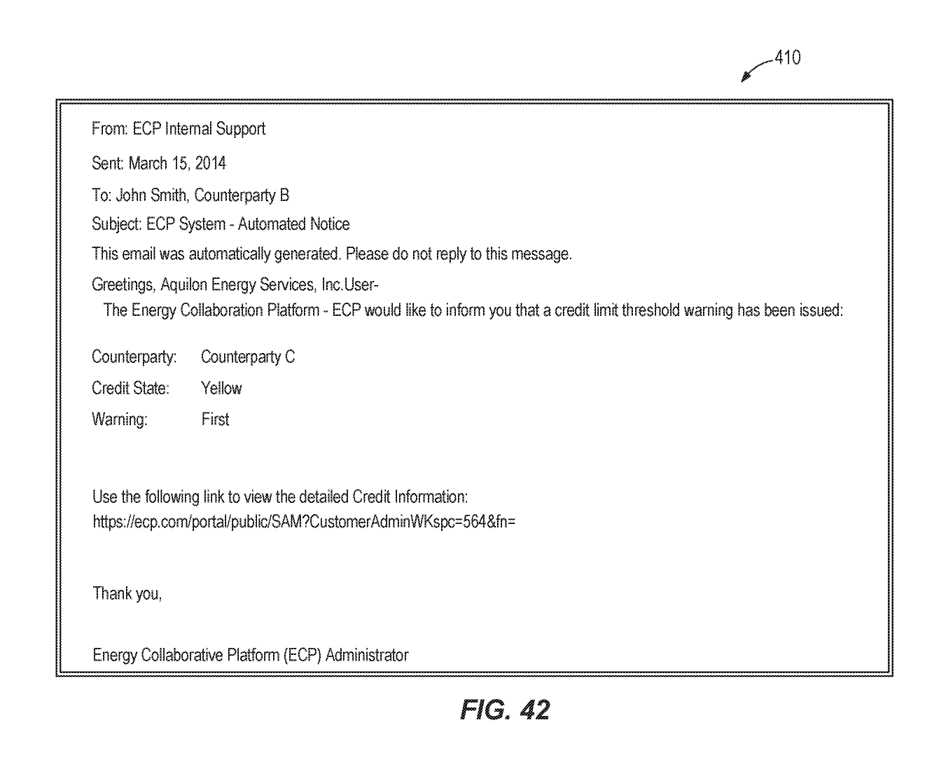

If a participant 50 is approaching a credit limit threshold or other user-defined limits (at block 408 in FIG. 8), the ECP calls the notification module 30 to notify both counterparties by generating a credit limit threshold notification 410 (see FIG. 42) (at block 412). The credit limit threshold notification 410 can include a credit state (e.g., yellow, red) and a warning number (e.g., first, second, third).

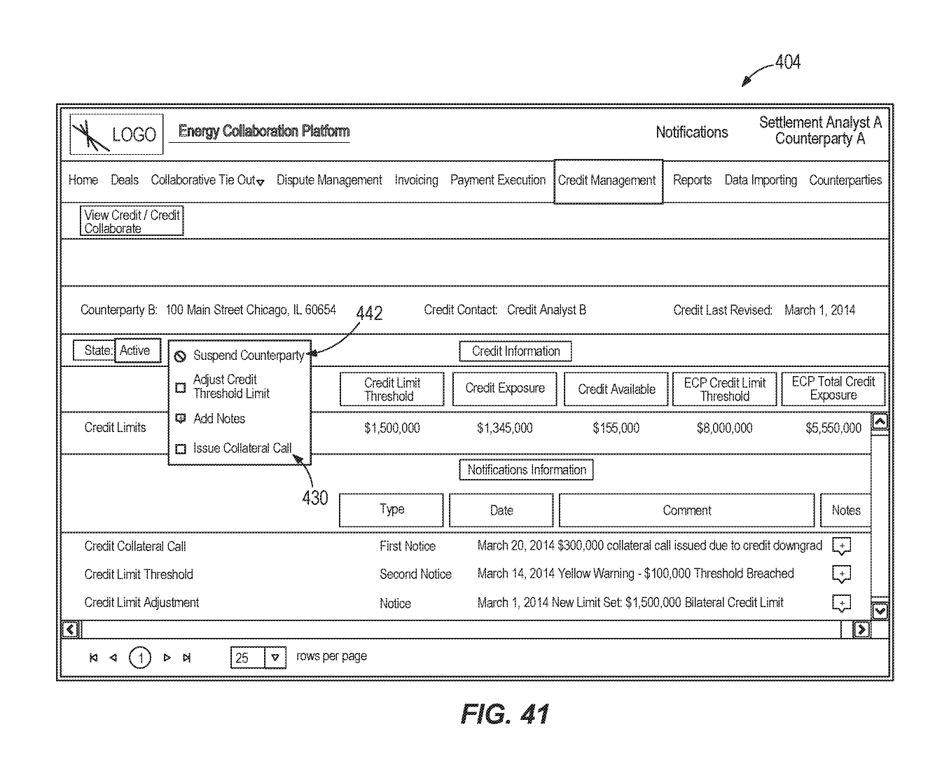

As illustrated in FIG. 41, Credit Analysts from the counterparties can collectively review the credit exposure information and may take action through the credit collaborate screen 404 (at block 414). The actions can include adding public and/or private notes to facilitate credit review, issuing a collateral call for additional collateral, adjusting a credit threshold limit, and suspending a counterparty relationship.

If a collateral call is desired (at block 416), the Credit Analysts can determine if the collateral call is met by engaging in an offsetting transaction for which the counterparty buys back an existing sale or sells an existing purchase of forward bilateral transactions to satisfy the collateral call (at block 418). If an offsetting transaction is used, one of the Credit Analysts notifies the respective Risk Analysts to enter revised transaction details in respective transaction systems of record 51 (at block 420). In some embodiments, the ECP also notifies the respective Risk Analysts to enter the offsetting transaction details in their respective transactions systems of record and to add clarifying comments to the transaction record to maintain an audit log (at block 422). The Risk Analysts update the transactional information in the transaction system of record 51 (at block 424). After the transaction data is revised, the transaction is re-imported from the transaction system of record (e.g., via the interfaces module 22 or via manual entry). The data can then be loaded and selected into the appropriate tie-out period workspace at which time ECP includes the transaction in the real-time match process described above.

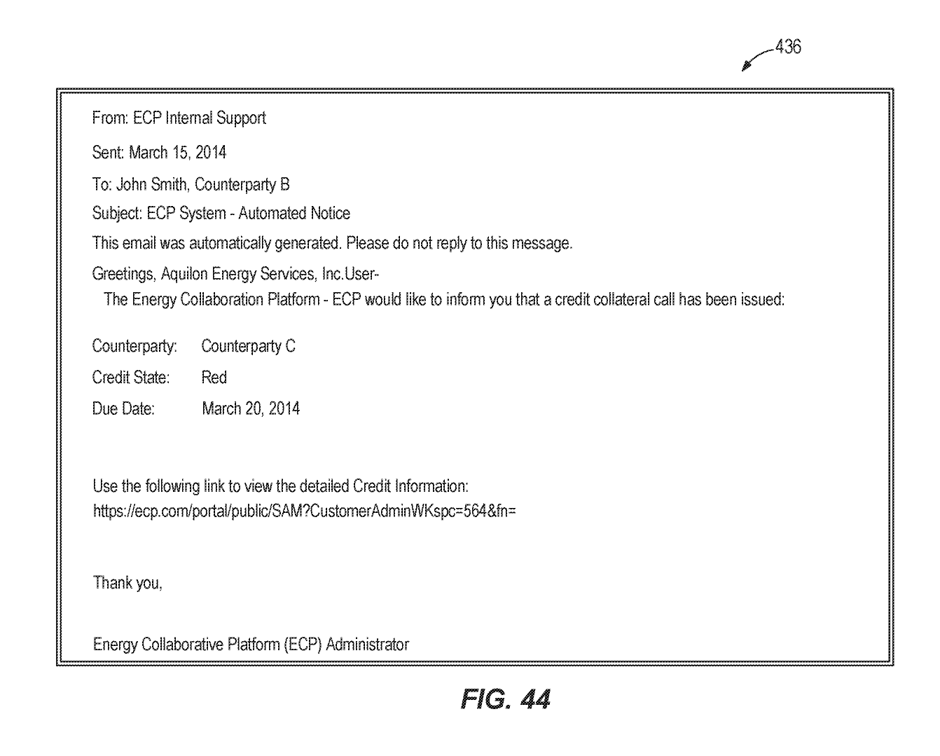

If a collateral call is desired (at block 416) and some or all of the call amount is being met with additional margin (at block 418), a Credit Analyst can select an “Issue Collateral Call” selection mechanism 430 as illustrated in FIG. 41 and can enter the dollar amount of the collateral call (at block 432). In response, the ECP calls the invoicing module 32 to generate a collateral call invoice based on a user configurable collateral invoice format, which includes the identification of the payment deadline to make payment (at block 434). Upon creation of the invoice, the ECP notifies both participants (i.e., the payee and the payor) that the invoice for the collateral call is available and ready for approval. For example, the ECP can call the notification module 30, which can generate a credit collateral call notification 436 as illustrated in FIG. 44 and a payment ready invoice notification 206 as illustrated in FIG. 25. The Credit Analyst monitors the invoice payment status, and, upon payment, the ECP reduces the credit exposure.

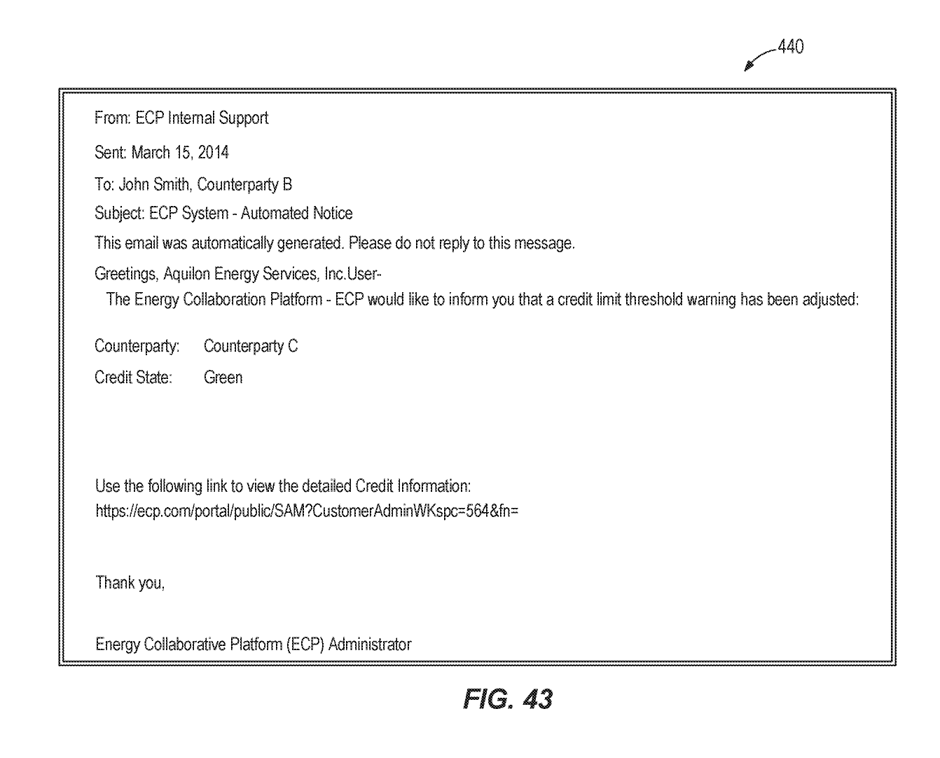

Alternatively or in addition, if a Credit Analyst determines that a credit limit adjustment should be made, the Credit Analyst selects the “Revise Credit Limit” selection mechanism 438 illustrated in FIG. 41. Selecting the “Revise Credit Limit” selection mechanism 438 prompts the user to enter the revised credit information and calls the notification module 30 to generate a credit limit adjustment notification 440 (see FIG. 43) for both counterparties. In some embodiments, the credit limit adjustment is made in an external risk management system such as an ETRM and the information is imported via the interfaces module 22. The interfaces module 22 can then call the credit management module 36 to update the revised credit limit threshold and generate the credit limit adjustment notification.

Alternatively or in addition, if a Credit Analyst determines that a relationship should be suspended, the Credit Analyst selects a “Suspend Counterparty Relationship” selection mechanism 442 illustrated in FIG. 41. Selecting the selection mechanism 442 calls the notification module 30 to generate the credit limit threshold notification 410 (see FIG. 42) with suspension information.

Accordingly, based on configuration information established using the counterparty administration module 14 and the master agreement management module 16, the ECP can perform the credit management process 66 in an automated, partially automated, or manual fashion.

As described above, to complete a tie-out process with each counterparty, a settlement analyst conventionally manually matched multiple types and levels of energy information with their counterparty's information from their respective invoices/remittance advices. Each energy invoice/remittance advice can include different transaction types (e.g., power sales, gas purchases, firm pipeline transportation, etc.) based on the business activity for the billing period between the two parties. Energy invoices can also include multiple levels of transaction type data including (1) invoice level, (2) product level, (3) deal level, (4) transport level, and/or (5) detailed transaction level. In most situations, both counterparties have a settlement analyst that manually tie-outs the information on each invoice.

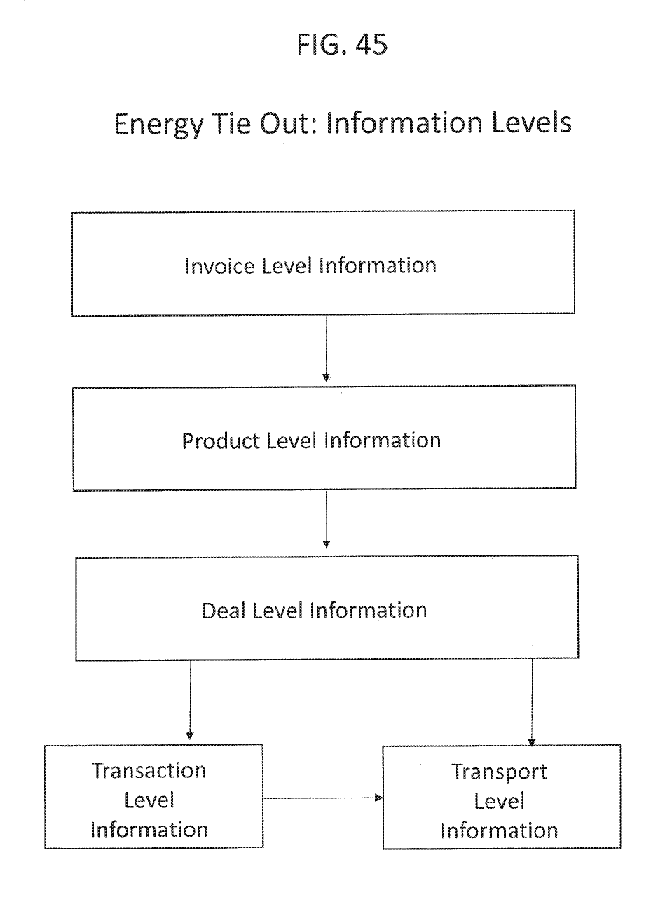

Invoice level information can include both volumetric totals (e.g., megawatts, spinning reserves, capacity, millions of British Thermal Units (“MMBTUs”), non-firm transportation, etc.) and financial totals (e.g., USD, etc.). Invoice level information can be decomposed at the product level. Product level information can also include volumetric and/or financial totals for a specific product. Product level information can also include deal, transport and/or detailed transaction level information. The deal level information can also include volumetric and/or financial totals for a specific deal and can also include additional energy settlement information including but not limited to deal start and end dates and deal pricing details (e.g., price indices, price location codes, etc.). Deal level information can be composed of transport and/or detailed transaction information. Transport information can include volumetric and/or financial information related to transportation and can also include specific transportation information including but not limited to pipeline/transmission grid information, location information, delivery point information, and meter information. Transport information and/or deal information can be composed of detailed transaction information. Detailed transaction information can also include volumetric and/or financial totals. Each level of information can also include adjustments from prior tie-out periods that have been processed in the current tie-out period. Relationships between the levels of information in an energy settlement workbook are illustrated in FIG. 45.

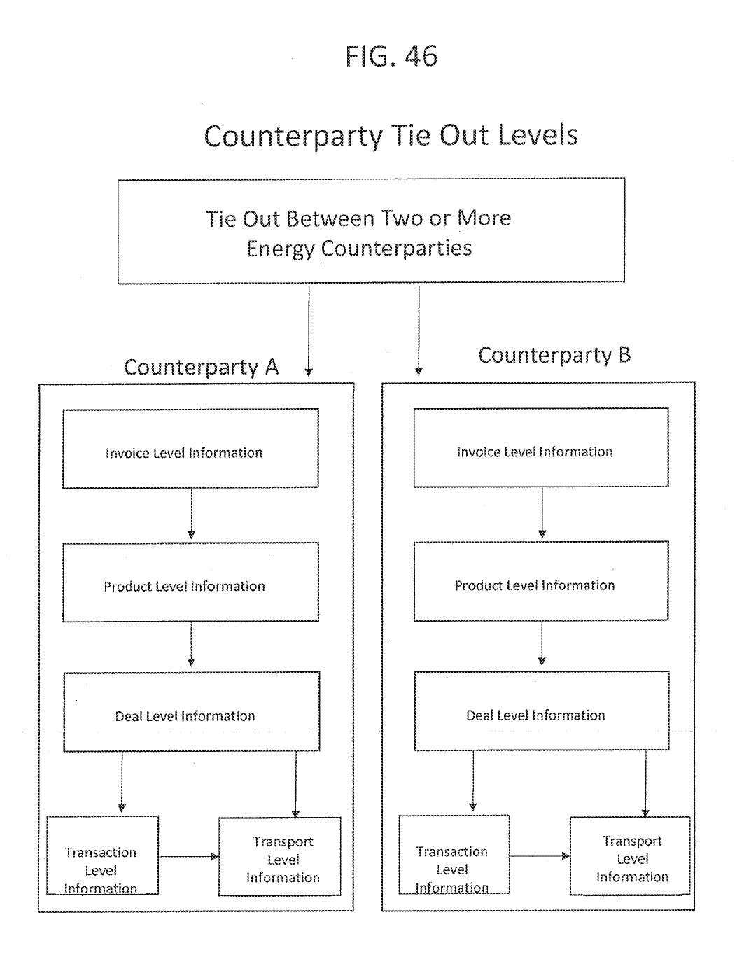

During a manual tie-out process, the settlement analyst manually matches the information produced by their company against the information produced by their counterparty. Any differences between the information are flagged as variances and must be investigated prior to the tie-out being completed. Variances are investigated by manually reviewing lower levels of information to determine which information does not match. For example, if the invoice information between two counterparties does not match, the settlement analyst will manually determine which product level information has variances. If the product level information does not match, the settlement analyst will manually determine which deal level, transport level, and/or transaction level information does not match. If the deal level information does not match, the settlement analyst will manually review the transport level and/or detailed transaction level information to determine the source of the variance. Thus, each settlement analyst performs a manual comparison between two workbooks of energy settlement information, which may contain multiple information levels as illustrated in FIG. 46.

A counterparty's invoice, however, may not be accompanied by multiple levels of information, which a settlement analyst needs to perform the manual tie-out process. Accordingly, a settlement analyst often needs to request additional information from a counterparty to complete the tie-out process and, if the counterparty is not responsive to the request, the settlement analyst can miss deadlines for completing the tie-out process. For example, some counterparties will include multiple levels of information (e.g., invoice level information, product level information, deal level information, and delivery level information) However, other counterparties will only provide invoice level information (e.g., a summary level number). For these counterparties, a settlement analyst traditionally has to manually contact the counterparty (e.g., via email, fax, a telephone call) and request the needed information, which can even include invoice level information. Thereafter, the settlement analyst must wait for and identify when the requested information is provided.

Also, a settlement analyst may also need to make multiple requests for information to perform a manual match. In particular, a party may want to limit the amount of information provided to the counterparty. For example, Counterparty A may not provide initial information to Counterparty B unless Counterparty B asks for the information. Counterparty A may then only provide information at the invoice level that responds to the request from Counterparty B. If the settlement analyst for Counterparty B cannot perform a match based on the invoice level information provided by Counterparty A, the settlement analyst for counterparty B will need to make another request to Counterparty A for more information at the product, deal, transport, and/or detailed transaction level information. As another example, Counterparty C may provide deal level information, but the deal level information may not match the deal level information of Counterparty B. In this situation, the parties can agree to exchange transport and detailed transaction level information to determine the cause of the variances.

Accordingly, embodiments of the invention provide systems and methods for automatically matching wholesale energy transactions; identifying variances between two or more energy transactions provided by two or more counterparties; and requesting, from counterparties in the tie-out, additional levels of information needed to resolve variances. The systems and methods use each counterparty's energy transaction workbook, which may contain information including but not limited to invoice level information, product level information, deal level information, transport level information, and/or transaction level information, to identify both matched information and variances between counterparties.

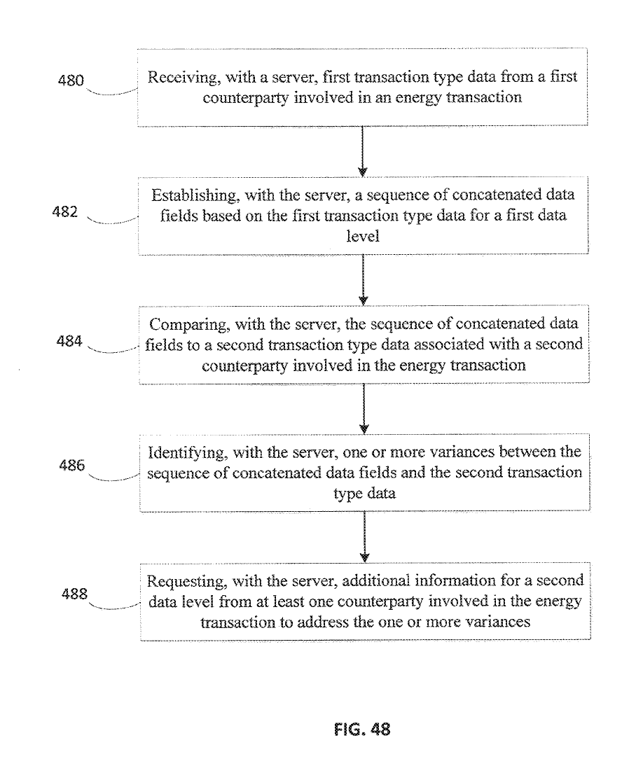

In particular, the ECP (e.g., the application server 2, such as the real-time trade matching engine 28) automatically determines and requests additional information needed from one or more parties to perform the tie-out process by automatically matching the energy transaction information provided by the counterparties and determining the variance (e.g., unmatched information) between the information of the counterparties in the tie-out. To perform the match, the ECP (e.g., the real-time trade matching engine 28) establishes a unique sequence of concatenated data fields provided by the first counterparty and compares the information to the same unique sequence of concatenated information provided by the remaining counterparties in the tie-out. The ECP marks all information as either matched or unmatched. The ECP then calculates totals of both matched and unmatched information at each level of information shared by the counterparties in the tie-out. The ECP determines variances by totaling the unmatched information from either counterparty in the tie-out (see FIG. 48). The ECP uses a different sequence of concatenated information for each level of energy information matched by the ECP. The specific sequence of information includes one or more information fields associated with an energy transaction, including but not limited to volumetric, financial, and transport information.

If the ECP determines that there is a variance (e.g., differences between the volumetric, transport, and financial information) at a level of information, the ECP automatically requests the next level of information from each counterparty to determine the root cause of the variance. The ECP only requests information from a counterparty that has not provided the level of information. The ECP can make a request for additional levels of information using automatically generated email(s) or electronic notification(s). In some embodiments, a party can specify who should receive requests for additional levels of information and communication preferences for such recipients (e.g., email versus facsimile). Also, in some embodiments, the request for additional levels of information can be made directly to an information system associated with a party. In addition, in some embodiments, a party may initially provide multiple levels of information to the ECP but may specify that the ECP can access such information only on an as-needed basis. For example, if there is variance at the invoice information level, the ECP may not access any levels of information below the invoice level. In these situations, the ECP may need to request access to lower levels of information by notifying a party that a variance has been detected that warrants access to such data. Accordingly, the ECP can automatically match energy transaction information contained in a tie-out at the lowest level of information provided by each counterparty that is shared by the parties to the tie-out and automatically request information needed to resolve the variances.

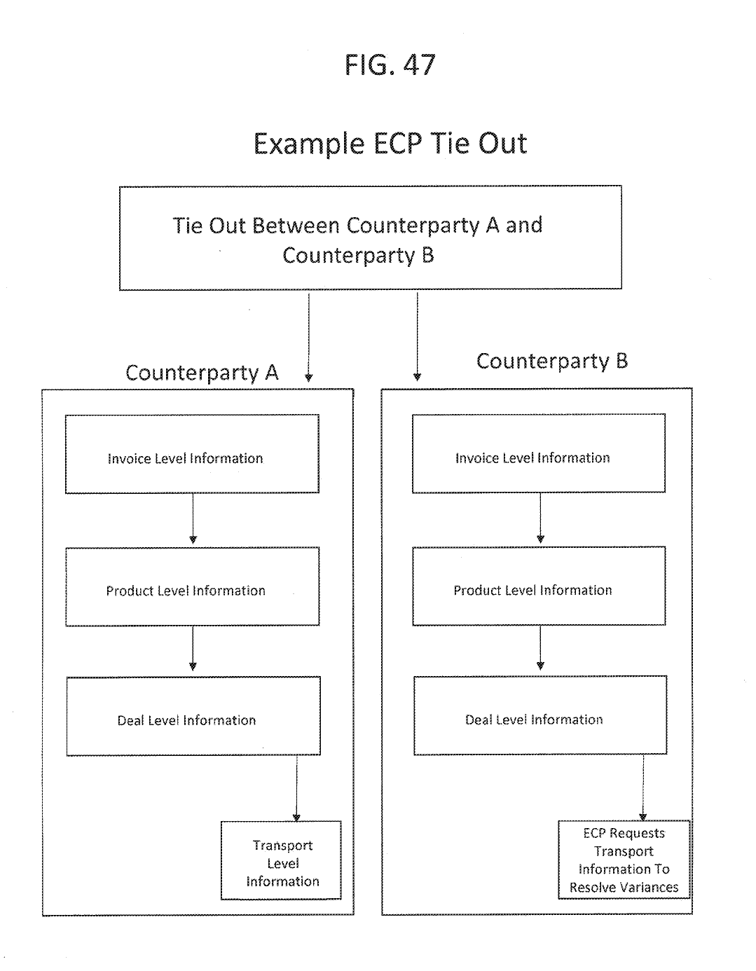

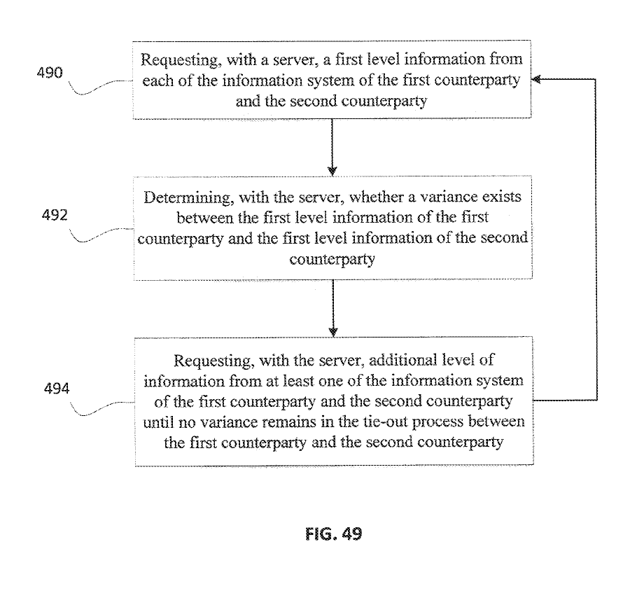

For example, in a tie out between counterparty A and counterparty B, assume the two counterparties have both have provided invoice level, product level, and deal level information. Counterparty A has also provided transport level information to the ECP. All of the information has been provided to the ECP via an automated interface on schedules unique to the information processing of each party. As the information is interfaced by each party to the ECP, the ECP performs the automated matching and variance analysis process at the invoice, product, and deal level of information (e.g., the common level of information between the counterparties for the tie-out). As the ECP determines variances between the invoice, product level, and/or deal level information, the ECP automatically requests additional information from Counterparty B at the transport level because Counterparty A has already provided this information to the ECP (see FIG. 47). The ECP continues to request additional levels of information from one or more of the counterparties in the tie-out until there is no remaining variance in the tie out (see FIG. 49). In some embodiments, the ECP requests the additional level information from the two counterparties based on a pre-determined hierarchy.

Thus, embodiments of the invention provide, among other things, systems and methods for conducting a wholesale energy transaction settlement process. It should be understood that the ECP can be configured to perform one, a subset, or all of the functions described above. Accordingly, the ECP can be configured to meet the requirements of particular counterparties. It should also be understood that although particular participant roles have been provided in the above descriptions regarding the functionality performed by the ECP, the functionality may be performed by other user roles within a particular participant.

What is claimed is:

1. A method of automatically matching energy transactions between two or more counterparties, the method comprising:
receiving, with a server, first transaction type data from a first counterparty involved in an energy transaction;
establishing, with the server, a sequence of concatenated data fields based on the first transaction type data for a first data level;
comparing, with the server, the sequence of concatenated data fields to a second transaction type data associated with a second counterparty involved in the energy transaction;
identifying, with the server, one or more variances between the sequence of concatenated data fields and the second transaction type data; and
requesting, with the server, additional information for a second data level from at least one counterparty involved in the energy transaction to address the one or more variances.

2. The method of claim 1, wherein requesting the additional information includes automatically generating at least one of an email and an electronic notification provided to a representative of the at least one counterparty.

3. The method of claim 1,wherein requesting additional information includes automatically accessing stored information previously submitted to the server by the at least one counterparty and notifying a representative of the at least one counterparty of the access.

4. The method of claim 1, wherein receiving the first transaction type data includes receiving at least one selected from a group consisting of invoice level data, product level data, deal level data, transport level data, delivery level data, and detailed transaction level data.

5. The method of claim 4, wherein receiving the invoice level data includes receiving at least one of volumetric data and financial data.

6. The method of claim 4, wherein receiving the detailed transaction level data includes receiving at least one of volumetric data and financial data.

7. The method of claim 4, wherein receiving the transport level data is selected includes receiving data selected from the group consisting of pipeline data, transmission grid data, location data, delivery point data, and meter data.

8. The method of claim 1, wherein receiving the transaction type data includes receiving data from a prior tie-out period.

9. The method of claim 1, further comprising:
establishing, with the server, a second sequence of concatenated data fields based on the additional information for the second data level, wherein the second sequence of concatenated data fields includes a sequence of data fields different than a sequence of data fields included in the first sequence of concatenated data fields;
comparing, with the server, the second sequence of concatenated data fields to the transaction type data associated with the second counterparty;
identifying, with the server, any variances between the unique sequence of concatenated data fields and the second transaction type data; and
requesting, by the server, additional information at different data levels until no variances remain.

10. A system for matching energy transactions, the system comprising:
at least one computing device comprising memory and at least one processor executing computer-readable instructions that cause the at least one computing device to:
receive a first transaction type data from a first counterparty involved in an energy transaction;
establish a sequence of concatenated data fields based on the first transaction type data for a first data level;
compare the sequence of concatenated data fields to a second transaction type data associated with a second counterparty involved in the energy transaction;
identify one or more variances between the sequence of concatenated data fields and the second transaction type data; and
request additional information for a second data level from at least one counterparty involved in the energy transaction to address the one or more variances.

11. The system of claim 10, wherein the at least one computing device automatically generates at least one of an email and an electronic notification provided to a representative of the at least one counterparty.

12. The system of claim 10, wherein the at least one computing device automatically accesses stored information previously submitted to the server by the at least one counterparty and notifying a representative of the at least one counterparty of the access.

13. The system of claim 10, wherein the first transaction type data includes at least one selected from a group consisting of invoice level data, product level data, deal level data, transport level data, delivery level data, and detailed transaction level data.

14. The system of claim 13, wherein the detailed transaction level data includes at least one of volumetric data and financial data.

15. The system of claim 13, wherein the transport level data is selected from the group consisting of pipeline data, transmission grid data, location data, delivery point data, and meter data.

16. The system of claim 12, wherein the first transaction type data includes data from a prior tie-out period.

17. A method of performing a tie-out process between information systems associated with a first counterparty and a second counterparty, the method comprising:
requesting, with a server, a first level information from each of the information system of the first counterparty and the second counterparty;
determining, with the server, whether a variance exists between the first level information of the first counterparty and the first level information of the second counterparty; and
requesting, with the server, additional level of information from at least one of the information system of the first counterparty and the second counterparty until no variance remains in the tie-out process between the first counterparty and the second counterparty.

18. The method of claim 17, further comprising:
requesting additional level information from at least one of the information system of the first counterparty and the second counterparty when at least one of information system of the first counterparty and the second counterparty has not provided the additional level information.

19. The method of claim 17, wherein requesting the additional level information from at least one of the information system of the first counterparty and the second counterparty includes automatically requesting and receiving additional information from the information system associated with at least one of the first counterparty and the second counterparty.

20. The method of claim 19, wherein the requesting the additional level information from at least one of the information system of the first counterparty and the second counterparty includes sending a request for access to additional level information based on a pre-determined hierarchy.
